(19) United States
(12) Patent Application Publication
(10) Pub. No.: US 2008/0189625 A1
(43) Pub. Date: Aug. 7, 2008

(54) Messaging system and method

(76) Inventors: Idan Zuta, Petah Tikva (IL); Marc Zuta, Petah Tiva (IL)

Correspondence Address: IDAN ZUTA, 19 BEN YEHUDA STREET, P.O. BOX 2162, PETAH TIKVA, 49120, omitted

(21) Appl. No.: 11/979,967

(22) Filed: Nov. 13, 2007

(30) Foreign Application Priority Data
May 11, 2005 (GB) GB 0509591.4
May 11, 2006 (IL) PCT/IL2006/000560

(51) Int. Cl. G06F 3/048; G06F 15/16

(52) U.S. Cl. 715/753

(57) ABSTRACT

A method for messaging personal pictures with others includes means for achieving a controlled level of sender's personal exposure with each recipient. A controlled level of sender's personal exposure is achieved by evaluating the picture and transmitting or displaying it only if predefined criteria regarding the evaluation results vs. characteristics of the intended recipient are met. A system for messaging personal pictures comprising means for storing pictures, means for pictures evaluation and means for pictures transfer or display according to the evaluation results.

### FIELD OF THE INVENTION

This invention relates to a system and method for supporting pictures messaging, by sending and exchanging personal photographs or streams of images through electronic means.

### CROSS-REFERENCE TO RELATED APPLICATIONS

The present application is related to, and claims priority from, the patent application No. GB 0509591.4 filed on May 11, 2005 in the United Kingdom and entitled “Messaging system and method”, and international application No. PCT/IL 2006/000560 filed on 11 May 2006 filed by the present inventors.

### BACKGROUND OF THE INVENTION

### Copyright Notice

Copyright (c) 2005 by Idan Zuta and Marc Zuta. The copyright owners have no objection to a xerographic reproduction of the patent document as published by Government Patent Authorities, but otherwise reserve all copyright rights.

The moral right of the authors has been asserted.

IseePic™ is claimed as a trademark by the present applicants.

The Internet allows for worldwide communications between people. People desire to meet and know each other, to present themselves and learn about the other party. At present, a large part of the communications is textual. Such communications may be limited and unsatisfactory at times.

A picture is worth a thousand words. It would be desirable for people to communicate in pictures, to expose themselves to others.

However, such a powerful means as the picture, when combined with the powerful Internet global communications, may be abused so as to cause damage to a user and/or to lead to illegal activities.

Today, a user wishing to expose himself to another would have to send his picture, to expose himself through a webcam, etc. This may create problems or requirements which are difficult/impossible to meet, for example:

1. Possible loss of privacy: The user is afraid to reveal his face, having his photo spread all over the Internet and having people laugh at his expense, for example. On the other hand, sending a low resolution photo is not revealing and may be unclear.

2. The user might prefer to reveal only one or more parts of the photo, the user might wish to control the resolution of the image. This might be cumbersome, requiring scanning, editing and saving. It may even be impractical in a real time environment, or with webcam streams, or when being performed with a plurality of pictures and recipients.

3. The user might wish to reveal to the other side only as much or in a similar manner as the other side exposes, for example sending only a low resolution pic in case the other side decides to do the same.

4. The user might wish to control and define instantly the amount of exposure in a picture and the level of trust put on the other side, which can be expressed in a quantitative, numerical form. This allows the user to define how much trust he has on the other side.

5. The user might want to operate a webcam at a very low resolution or to block part of the picture, so he will not be exposed.

This to achieve privacy and/or to save bandwidth.

However, blocking part of a picture may not be effective if the user moves about.

### SUMMARY OF THE INVENTION

According to the present invention, a system and method are provided for facilitating the transmission of personal pictures to others so as to achieve a controlled level of personal exposure with each recipient, while maintaining security and protecting the sender.

Personal pictures generally refer to pictures of a person, including his/her face and/or body and/or parts thereof. Such personal information as disclosed therein may be the subject of processing using the method and system presented in the present invention.

The processing of personal information in the pictures may include the evaluation, editing, transmitting and managing of the pictures.

In a preferred embodiment, processing refers to activities performed by someone on pictures of himself. Alternately, the person may set up a system or method for performing these activities in his behalf. Again, the parent of a child may perform such activities on behalf of that child.

A picture evaluation may include computing or setting its characteristics such as the Resolution, Quality, Level of Exposure, Grade and/or Class of the picture. These terms have a special meaning in the present invention, as defined below.

Personal Picture editing may include various processes for changing the picture so as to change its appearance and characteristics.

Transmitting pictures methods/systems may use the pictures characteristics thus defined, as well as the class and access rights assigned to each of other persons/potential recipients of the picture.

Management of personal communications includes keeping track of pictures and their characteristics, as well as properties assigned to a plurality of other persons with whom the user may desire to communicate. The system/methods also keeps track of and logs the communication activities performed with others, analyzes these activities and presents relevant recommendations to the user.

The invention allows easier management of, and access to, the photos of the user, in accordance to the access level assigned to each recipient of said photos, as defined by the user.

The invention can be especially useful for users of equipment connected to the Internet, who desire to chat and to meet others, while exposing of themselves as much as possible, but gradually and without revealing too much initially. There may be a problem of too much disclosure in sending a high resolution photo, while sending a low resolution photo is not very informative.

This can also be useful when using a messenger software and wishing to give one's friends a limited access to photos, according to one's feelings and to mutual interests.

The invention may be also implemented within cellular phones, with or without a camera, to allow sending photos to others, whilst controlling the quality of the photo, as may be defined.

Another aspect of the present invention includes a new portable pictures storage/display/transfer system. The system may store pictures, manage pictures transfer to/from the device, implement a smart picture edit method and display the pictures.

One can show digital pictures to friends, while censoring them in a different way for each of one's acquaintances, as desired.

Pictures source: digital cameras are now widely used, but expensive. A new pictures viewer can be lower cost; there is no need for a hard copy or PC. It can show a different grade/class of pictures to each friend.

In another embodiment of the invention, a webcam is enhanced with user protection means and remote control means.

Remote control—zoom, orientation control (1 or 2 axes: azimuth, elevation) and/or picture rate and exposure time from PC.

Problem—privacy, the webcam can get out of control, may operate not as the user intended it to. The user sets the camera in one direction, but a computer virus moves it into another direction and zooms in.

Thus, until now webcam control was not practical—it could get out of control, send pictures the user did not plan/intend to be made public.

But—with our privacy protection means, it can be permitted.

According to the present invention, a system and method are provided for processing personal pictures, while maintaining security and protecting the sender.

### Benefits of the Invention:

1. Pictures are a powerful means for conveying a message to another party. Personal pictures more so, are used as means to present oneself to others.

2. A processed picture conveys both the physique of the sender and his/her personality, as expressed in their editing of their picture.

3. A dialog in pictures may be maintained between two persons, with each of them sending, in turn, processed pictures to the other. People may thus get to gradually know each other. Pictures may enhance and enrich a chat.

4. One-to-many or many-to-many communications using processed pictures may also be implemented, to help people to find what they are looking for.

5. The new method and system allows these and other benefits, while also protecting the sender. The user needs not worry that his/her private photos will spread all over the Internet, for example.

Versatile and powerful tools are available to the user, to protect his/her privacy, prevent illegal activities or abuse, and keep track of ongoing communications in pictures.

The user protection is commensurate with the powerful pictures and Internet.

The protection tools of paragraph (5) above may include, for example:

A. The user is provided with means for easily control and pre-set how much is he revealing and to whom. An access level can be easily set for each person communicating with the user. Thus, it can be possible, for example, that two people would see the user through a webcam, however each will see him with different resolution, or different areas of his image, according to the access level of each of the viewers.

B. Smart, powerful picture edit operators may be used to create versions of a picture, corresponding to various degrees of privacy/exposure.

The user can reveal only one or more parts of the photo; the user can control the resolution of each part of a photo, and may censor out parts of the photo. The user may edit the picture easily, even in real time.

C. Reciprocity/fairness: The user can reveal to the other side as much or in a similar manner—by exchanging photos with similar quality, for example.

Each of the users may let the system give a grade to each photo, then they can fairly exchange photos of similar quality according to that grade. The system may automatically perform a fair exchange of photos or may advise the user in a manual pictures transmittal.

D. The user can control and define instantly the amount of exposure to, and the level of trust in the other party, which can be interpreted by an axis meter or an access level in the system. Such settings may be based on one's impressions during a chat or pictures received. Once defined, these settings will guide the user in subsequent pictures exchanges.

E. The user can operate a webcam at a very low resolution or only partially, without being exposed. This can also save bandwidth. Several people can each see other parts at another resolution, as defined by the user.

Additional benefits and other features and advantages of the present invention will become apparent to persons skilled in the art upon reading the present disclosure and the drawings.

### BRIEF DESCRIPTION OF THE DRAWINGS

FIG. 1 illustrates various choices for picture area selection from a person's face picture.

FIG. 2 illustrates various alternatives for picture area selection and processing from a picture of a person's body or face.

FIG. 3 details, in flow chart form, a method for sending a picture fast, spontaneously, without Grades, in real time, from a real time source.

FIG. 4 details, in flow chart form, a method for sending a picture without Grades, in real time, from a storage source.

FIG. 5 details, in flow chart form, a method for sending a picture with Grades, in real time, from a real time source.

FIG. 6 details, in flow chart form, a method for sending a picture with Grades, in real time, from a storage source.

FIG. 7 details, in flow chart form, a method for sending a picture without Grades, not in real time.

FIG. 8 details, in flow chart form, a method for sending a picture with Grades, not in real time.

FIG. 9 illustrates a picture messaging system contained in a user's PC.

FIG. 10 illustrates a picture messaging system with the software and pictures stored on a server on the net, under control from a user's PC.

FIG. 11 details a system supporting smart pictures edit and grade setting to edit/censor pictures.

FIG. 12 details a pictures processing interface system for a webcam.

FIG. 13 details an add-on system for smart picture processing in a camera, cellular phone, SIMM, card, etc.

FIG. 14 details a portable pictures storage/display/transfer system for immediate, easy display to user in a low cost, portable device.

FIG. 15 details a webcam enhanced with integrated user protection means and remote means for controlling the orientation of the webcam from the PC (its azimuth and elevation angles and its zoom).

FIG. 16 details one embodiment of a menu to user.

FIG. 17 details, in flow chart form, a method for sending a PV.

FIG. 18 details a method for bandwidth management.

FIGS. 19a and 19b compare a relatively complex vs. a relatively simple implementation, respectively.

FIG. 20 illustrates, in flow chart form, one embodiment of a method for initiating a mutual mode.

FIG. 21 illustrates one embodiment of a picture management method for presenting onscreen the various picture originals and picture versions.

FIG. 22 details a screen/menu for viewing each person's details together with the original pictures and PVs which have been sent to that person.

FIG. 23 details a screen or menu for viewing the PVs that were received versus the PVs which were sent.

FIG. 24 details a screen or menu for defining the steps, and managing the revealing of, one or more PVs to others.

### DETAILED DESCRIPTION OF THE PREFERRED EMBODIMENTS

Terms used in the present disclosure:

Photo/picture—throughout the present disclosure, whenever one of the following terms is mentioned, it is to be understood that the same also applies to the other terms listed herein: Photo, photograph, image, picture, pic, file, stream of images, digital photo, stream from webcam, version OP, PV or similar terms.

The term may refer to one picture or a stream of pictures or frames; to be processed either in real time or not.

Original picture OP—picture as acquired, from a camera or scanner for example.

Picture version PV—the result of a picture editing or manipulating (of an original or another version).

In one embodiment, a PV may be in the form of a new picture.

In another embodiment, a PV may comprise a link to an existing picture or PV together with operators so defined as, when acting upon the above picture, will achieve the PV with the desired effect(s).

A PV may be a stream of images, may be taken from storage or may be defined as operations related to other picture.

User—the owner/holder of pictures, a person, software and/or hardware that uses the technology described in this invention to perform various operations possible using this invention, such as: edit, manage, examine, send and/or receive pictures.

Recipient—a person or other people or software and/or hardware, whoever receives the picture. Pictures may be sent either directly or indirectly, in RT or not in RT.

The term also refers to a tentative/contemplated recipient who will not become an actual recipient if he/she is prevented from receiving the PV.

Real time (RT)—receiving a picture which has been formed a short time ago in any type of camera, and/or sending now a picture. RT may apply to the near future as well, such as automatic operations done in RT for sending a PV which is a stream from a webcam, and will continue according to need.

It may be implemented with a webcam or other camera or another source delivering a stream of images.

Resolution—the pictorial/visual information contained in a personal picture, in a person's body and/or face.

Quality—a value indicating the interest in the picture, derived from the resolution values and their relative importance to the user.

Exposure—a value indicating the measure of intimacy revealed in the picture. It may take into account the specific private areas present in the personal picture and the resolution/quality in each area.

Grade of picture—also Grade or GR.—a number assigned to a picture, indicating the degree of its privacy to owner/sensitivity to its disclosure.

Class of picture—defines subjects/areas of activity/areas of interest for the owner of the pictures.

Access level AL (A.L.)—a number assigned to a recipient by the user/owner of photos, indicating that that person can see pictures having a Grade equal to, or lower than, his/her assigned A.L. value.

Editing of pictures—digital operations on pictures, in order to create new versions, this can be done automatically, manually or as a combination of the two. Editing may be done so as to match criteria or achieve a desired level of picture's characteristics, such as a specific grade and resolution. Editing is detailed below.

Encryption—public key encryption or any other encryption can be used when PVs are saved and/or while sending PVs, so that only the addressee can see these pictures.

MLS—Monitor, Log and Secure set of operators as applied to pictures. MLS is detailed below.

Any combination of these operations can be carried out as required, in order to handle pictures as desired by the user, and in accordance to any definitions set. MLS can include more or less options depending on implementation.

PC—personal computer; also Server, Central Computer, Mainframe, Work Station, Several servers including proxies routers etc., any Network; cellular phone, camera, palm PC, pocket PC, computer, webcam, similar or other electronic equipment.

Program or Software—also DLL, Plugin, Active-X, script, Function, TSR, API, Game, Application, Engine, Protocol, Library, Codec, Module, Operating system resources.

The invention will now be detailed, by way of example and referring generally to its following aspects:

1. Evaluating the characteristics of personal pictures

Characteristics relevant to pictures of persons are computed and/or defined; the results are used in the methods and systems detailed in this invention.

2. Personal pictures messaging method

The stages of messaging with pictures are detailed for various embodiments.

3. Editing of personal pictures

Pictures are edited to change their characteristics as defined in (1).

4. Managing communications with pictures

Algorithms for transmitting pictures are defined and implemented.

5. Personal pictures messaging system—New system embodiments can process personal pictures in a secure and effective way.

6. Menus to user—Effective menus allow user's control over the various stages of personal pictures messaging.

7. Interface/interaction with other programs/applications in a PC—These interface allow pictures messaging within contemporary computer systems.

1. Evaluating the Characteristics of Personal Pictures

The algorithms below may be implemented in hardware and/or software.

The characteristics of personal pictures may be defined as follows:

1. Resolution—the pictorial/visual information contained in a personal picture, in a person's body and/or face.

The resolution may comprise a table indicating, for each of a plurality of predefined parts of a human's body and/or face, the amount of information therein. In the present invention, the resolution is defined differently than in prior art.

See Method 1, an example of computing the Resolution of a picture.

2. Quality—a value indicating the interest in the picture, this can be a combination of resolution values (a weighted sum of resolution values). See Methods 2 and 3, examples of computing the Quality of a picture.

3. Exposure—a value indicating the measure of intimacy revealed in the picture. It may take into account the specific private areas present in the personal picture and the resolution/quality in each area. Exposure may be affected by the skin being exposed or covered in each area of interest. See Method 4, an example of computing the Exposure in a picture.

4. Grade of picture—also Grade or GR.—a number assigned to a picture, indicating the degree of its privacy to owner/sensitivity to its disclosure. See Method 5, an example of computing the Grade of a picture.

The Grade may be conveyed, for example, by a number on a scale from 0 (common to all) to 100 (for owner's eyes only or a few select).

5. Class of picture—defines subjects/areas of activity/areas of interest for the owner of the pictures.

See Method 6, an example of setting the Class of a picture.

A picture may include a person together with various backgrounds such as buildings, mountains, city traffic, vegetation, the ocean, etc.

This invention will focus on properties of the human person featuring in the picture. The five properties above refer to the person in the picture.

These properties were defined in one embodiment, by way of example. Other, similar properties may be defined in other embodiments.

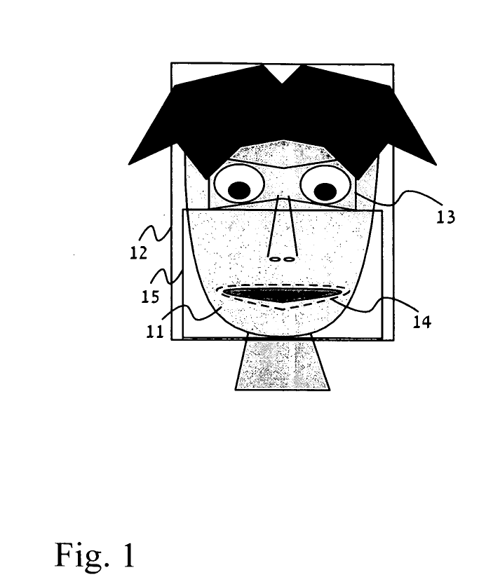

FIG. 1 illustrates various choices for picture area selection from a person's face picture. Various parts/areas of the photo can be described or presented to others. Software and/or hardware means can automatically trace the contour of a person's face 11, the eyes 13, the mouth 14, mouth and nose area 15 or an arbitrary area of interest 12 manually selected.

A picture's resolution/quality index can then be computed, for example based on the amount of data in the selected area. The system may count the number of pixels in the face area and optionally the number of bits allocated to each pixel. A pixel may be stored as one bit (monochrome) or more bits, i.e. 8 to 32 bits (color). A pixel represents one point of the picture, such as one point on screen.

A person's face, more than other parts of a picture, is often sought by others for identification, evaluation and/or acquainting purposes. Thus, according to the invention, it is the amount of data in this important area of the picture which is used to compute the resolution or quality of the whole picture.

Rational: a large and detailed picture of a prairie, featuring just a small representation of the other person, is of little use in getting to know that person. Another specific area of the face or body may be considered important by various people; such area may replace the face for the purposes of the present invention.

The new system and/or method may thus find/define the contour of the face and perform various calculations within the picture area thus defined.

For example, it is possible to define a quality for the photo, indicative of how much information is revealed. The number of pixels in a selected area may be indicative of this photo quality.

Alternately, the user may define an area of interest 12 manually, saving the need for means for supporting this option (automatic recognition of the face contour) in software and/or hardware.

The user can use graphic interface means to easily mark an area 13, for example when desiring to show the other person only the eyes, or maybe blocking the eyes, so that the other person can see most of the face, yet without a sure, definite/complete recognition of the person in the picture. Another option involves setting the resolution, separately in each area, for example setting the eyes at higher resolution while showing the rest of the face at a lower resolution.

It is possible, then, either to save the photo, define its grade manually and/or automatically, and of course sending it to other people, instantly or later, as desired. It is possible to define a class as well, so that even people with the required access level could not access photos which belong to another class.

The user can use a graphic interface to easily identify an area 14, for example identifying the mouth and lips, then deciding how to edit the selected area. The software can support an algorithm to identify areas in the face or in the body, allowing a faster and easier picture edit by the user. The areas thus selected can have any shape, and need not be rectangular. It is possible to select and define any arbitrary area 15, which can include some or all parts of other areas (partial/full overlap may be allowed).

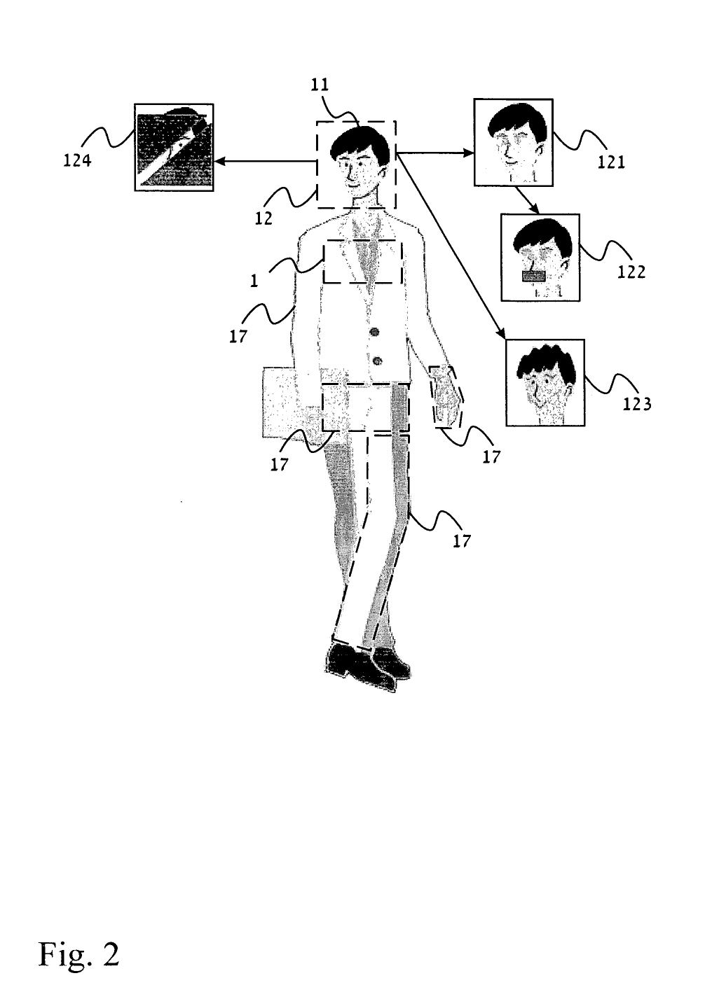

FIG. 2 illustrates various alternatives for picture area selection and processing from a picture of a person's body 1 or face 11. A possible selection may include a rectangular selection 12, another area 17, etc.

Various picture versions 121, 122, 123, 124 may be created from the original picture of the face per selection 12, using various picture editing/processing features/options.

Various areas 17 may be selected, for example: the head, eyes, hand, private parts, a foot.

### Method 1—Computing the Resolution of a Picture

The method includes:

a. automatic recognition of each part of a person's face and/or a person's body in a picture. The parts may include the mouth, nose, eyes, arm, hand, neck, thigh, breasts, etc. The list of relevant parts may change from one embodiment to another.

The eyes area may optionally include areas surrounding the eyes and including relevant personal information pertaining to a person's expression and characteristics.

Each part being recognized may be selected and distinguished from the rest of the picture, for subsequent processing.

The software and/or hardware may include guidelines relating to what to expect and search for, for each human part. These may include typical human shapes in various sizes and angles of rotation/aspect/views.

b. measuring the amount of information contained in each part thus selected.

Preparing a table with the amount of information in each part of the body and/or face. A body part which is not present in the picture or is blocked may be indicated as containing no information, or a resolution of zero. End of method.

### Notes

1. In one embodiment, the amount of information may include the number of pixels in a predefined area of the body or face.

Another measure indicative of the amount of information in predefined body/face areas may be used.

2. The Resolution may comprise a table indicating, for each of a plurality of predefined parts of a human's body and/or face, the amount of information therein.

This definition of Resolution may be used throughout the present disclosure. It differs from prior art, wherein resolution is defined as a unidimensional quantity indicating the number of distinguishable line pairs per unit length.

3. In a preferred embodiment, the recognition of each part of a person's face and/or a person's body is automatic.

Where it is desired to save in hardware or software complexity and cost, a manual method may be used, wherein the user points at the various areas of interests and defines them for the machine.

A semi-automatic implementation may also be used, wherein the user assists and guides the automatic recognition process, thereby facilitating it.

### Quality Definition Method

Define the quality of the photo—In an automated mode, this may be done according to the number of pixels in the face, for example. The face within the photo may be recognized automatically by the software. Another option would be to define the quality according to the overall resolution of the photo, without checking how much is actually revealed.

In another embodiment, the resolution of the body in the photo will also be recognized and defined.

A preferred embodiment of an algorithm for computing the quality of a picture, QualityA, will be now detailed.

### Method 2—Computing the Quality of a Picture

a. defining a user's criteria for Quality in a personal picture, indicating the importance of each body part as indicative of the level of interest in the picture. In one embodiment, this is indicated as a set of weights to be assigned to each part of face or body, W(n).

b. computing the Resolution in the picture, including for example an automatic recognition of each part of a person's face and/or a person's body and the information in each part.

c. computing the quality of a picture, QualityA, using the equation:

QualityA=ΣR(n)*W(n)

where Σ represents summing of terms over n
R(n)—resolution of area i of body or face; may be measured as the number of pixels in that area, or using another measure indicative of the amount of pictorial information in that area.
W(n)—weight assigned to area i, according to the measure of interest attached to that body area

End of method.

For example:

QualityA=(resolution of body)×0.4+(resolution of face)×0.6

Another preferred embodiment of an algorithm for computing the quality of a picture, QualityB, will be now detailed.

### Method 3—Computing the Quality of a Picture

a. defining a user's criteria for Quality in a personal picture, indicating the importance of each body part as indicative of the level of interest in the picture. In one embodiment, this is indicated as a set of weights to be assigned to each part of face or body, W(n).

b. computing the Resolution in the picture, including for example an automatic recognition of each part of a person's face and/or a person's body and the information in each part.

c. defining general picture quality—criteria and/or algorithms for its computation. The result A(n) may be for example a factor in the range 0 to 1.

The value of A(n) increases where there are less imperfections in the picture and/or where there is more actual information therein.

Possible imperfections may include noise, granularity or cracks.

Other picture properties relating to A(n) may include graininess, MTF, acutance, sharpness, adjacency effects, etc.

c. computing the quality of a picture, QualityB, using the equation:

QualityB=ΣR(n)*W(n)*A(n)

where
Σ represents summing of terms over n
R(n)—resolution of area i of body or face; may be measured as the number of pixels in that area, or using another measure indicative of the amount of pictorial information in that area.
W(n)—weight assigned to area i, according to the measure of interest attached to that body area
A(n)—general picture quality, for example a factor in the range 0 to 1.

d. More information may include more colors or gray values and/or an increased level of entropy. More information refers to unexpected info in the picture, i.e. a pixel differs from the average of pixels adjacent thereto.

The quality criteria can be defined by the user and/or can be calculated automatically.

End of method.

### Method 4—Computing the Exposure in a Picture

a. defining a user's criteria for Exposure in a personal picture, indicating the importance of each body part as indicative of the level of personal exposure in the picture. In one embodiment, this is indicated as a set of weights to be assigned to each part of face or body.

The importance of naked skin in each part may be optionally defined.

b. computing the Resolution in the picture, including for example an automatic recognition of each part of a person's face and/or a person's body and the information in each part.

c. computing the Quality of the picture.

d. An automatic algorithm may be used to find whether each area is covered or naked skin, using color, texture, other characteristics or a combination thereof. Alternately, a manual input from the user may indicate whether each area is covered or naked.

e. Computing the value of Exposure, an indice of the measure of intimacy revealed in the picture.

The algorithm may take into account the specific private areas present in the personal picture and the resolution/quality in each area. Exposure may be affected by the skin being exposed or covered in each area of interest.

The user may define exposure, as some users might feel that even revealing their face at a low resolution is considered as high exposure, for example.

The user may define specific exposure-related weights for each of the parts of the body and/or face, to be used in computing the Exposure value.

The Exposure may be computed as a weighted sum of resolution values for specific private areas, taking other variables into account as well.

The algorithm needs not be linear.

End of method.

The Grade of a picture (also Grade or GR.), is a number assigned to a picture, indicating the degree of its privacy to owner/sensitivity to its disclosure.

According to the quality of the image, which defines either roughly or more precisely, how much data of the user is available within the image, a grade can be given automatically, or this data can help the user to decide for a manual grade.

Following is an example of computing the Grade of a picture.

### Method 5—Computing the Grade of a Picture

a. defining a user's criteria for Grade in a personal picture, indicating the importance of each body part in this aspect, as well as the weight to be assigned to computed values of Resolution, Quality and Exposure in the personal picture.

The algorithm may indicate the level of personal intervention of the user/owner of the picture, in setting the Grade. For various values of Grade, different owner's involvement levels may be defined. Thus, for example, a low grade may be set automatically, whereas in a possibly high grade the user will be notified accordingly.

b. computing the Resolution in the picture (optional).

c. computing the Quality of the picture (optional).

d. Computing the value of Exposure (optional).

e. computing the Grade, using an automatic or manual algorithm or a combination thereof.

The Grade may be conveyed, for example, by a number on a scale from 0 (common to all) to 100 (for owner's eyes only or a few select).

The grade may be set by the user taking into account resolution, quality, exposure values and/or personal reasons, among others.

End of method.

The user may set the Class of a picture, which defines subjects/areas of activity/areas of interest for the owner of the picture.

### Method 6—Setting the Class of a Picture

a. defining Classes for the user/owner of personal pictures. A set of common/public classes may be used by all the users in the system. Alternately, each user or group of users may define classes as they may decide. Classes may be further subdivided into subclasses.

For example, Classes may include Friends, Family, Colleagues at work, Medical doctors, University officials, etc. Family may be further subdivided into spouse, children, parents, brothers and sisters, etc.

Preferably, a hierarchical Class structure is defined, with properties having upwards/downwards mobility (inheritance rules) as defined.

b. defining criteria for assigning a Class/Subclass to a picture. The assignment may be either manual or automatic.

Automatic criteria may include various clues, such as the name of the picture, the computer directory it is stored in, various predefined features in the picture, etc.

Another criterion may be the time the picture has been taken—the user sets a Class, then all the pictures taken subsequently belong to that class until a different class is defined.

Yet another criterion may be the sending of a picture to a specific recipient—all the pictures sent to the family physician are subsequently labeled as Private/Medical.

c. assigning a Class/Subclass to each picture, using either a manual or an automatic procedure, or a combination thereof.

End of method.

2. Personal Pictures Messaging Method

Picture messaging method—send pictures to another person. A picture can either be sent to another, or may be stored to be read/downloaded by others. This forms a visual messages communications. Can be done during chat or in response to received picture.

This section first presents a basic method, Method 7, detailing the various options open to user in implementing the invention.

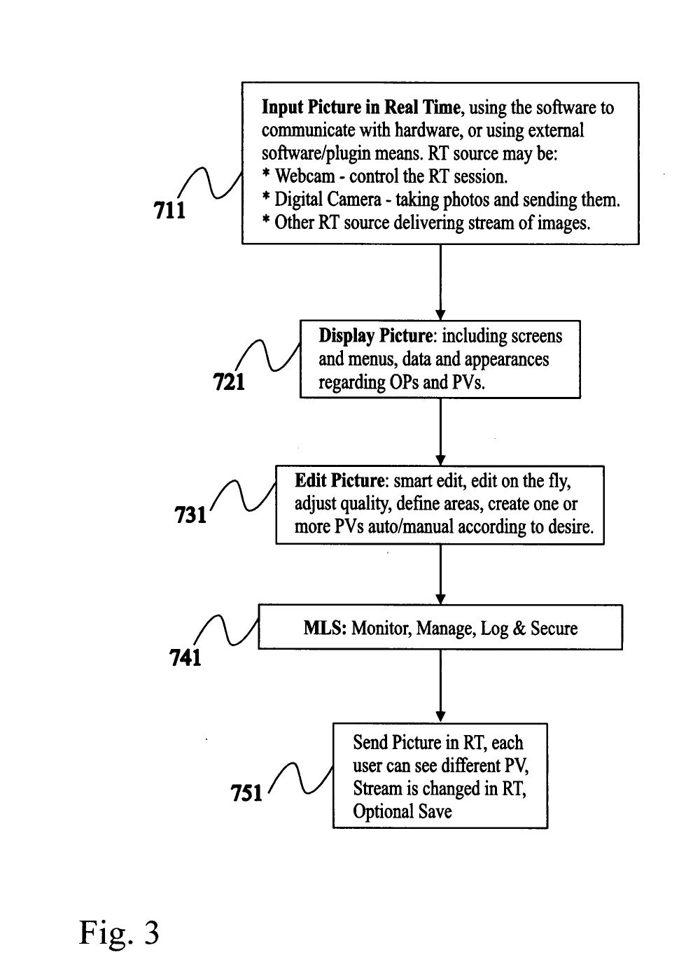

More specific Methods (8-14) are next detailed, to illustrate specific embodiments based on various choices in Method 7, with reference to FIGS. 3-8 respectively.

### Method 7—Basic Picture Messaging

The method includes:
a. select picture or stream of pictures=original or previous version; from storage or a real time source.
   Answer the question: “What picture is to be used now?”
b. display the selected picture and its info. If there is no previous info—it can be instantly computed or may be set manually—i.e. Grade, Class.
c. edit it—intelligent, manual/automatic. result: picture version PV. Optional—edit picture if required, to set its characteristic value(s). Change picture to adapt to intended use, to convey my message and personality. The edited picture is my message to you.
   Operators may include: Select area; enhance; censor, hide; reduce quality; visual manipulation/effects; encrypt for saving and/or for sending.

d. define info for picture: Grade, Class. Optional. Manual/automatic. Monitor info. Info is not part of picture, only related, points to it.

Other info: comments, what is this, for what purpose, for whom. Directions for others—to whom to show picture. Info for user, to help him/her keep track of pictures, their editing and transmissions.

e. send and/or save it. Send in real time or prepare for sending later. This is the ultimate purpose of the Method—to send it, now or later.
Upload to server or other computer/device.
Store the picture version, for backup and other purposes.
Gatekeeper: monitor pictures sent in real time, protect privacy and law.
Advise on fair/balanced disclosure with the other party.
Send=to other party, or upload to a server or other device.
Access level—manage A.L. of others, change to allow them to see more in RT, or enable/allow them to see later, such as by: server, email, direct when both online.

End of method.

Optional, support features:
f. view other, support info: my pictures, list of sent/received pictures, result of analysis of other picture (quality, parameters).
   Display info to help my decision, what to do
g. use existing picture editor
h. use existing browser, picture viewer, Internet applications, encryption programs (i.e. public key encryption/decryption), built-in functions, libraries, applications, DLL's, APIs, open connection protocols, communicating program.

End of method.

### Method 7B—Select/Input Picture

The method for identifying the source of photos or Streams and input pictures may include:

a. Loading one or more photos or stream of images from any source, memory, and/or hardware/software means such as:

Hard Disk Drive HDD, Compact Disc CD, Floppy Disk Drive FDD, Disk on Key, Flash memory, RAM of any kind, Network connection, Universal Serial Bus USB connection, via Wireless means such as through a Bluetooth link, GPRS, GSM, CDMA or WAP Connection, MMS, etc.

b. The photos may be taken from a webcam, digital camera, or any other kind of camera or video source in real time, or from a record.

c. All of these possible inputs for photos or images will be referred as the Source.

End of method.

Various choices of the above steps/features may create different methods, to be used as required. Below are detailed several such methods/embodiments of the invention, to be detailed in the present disclosure:

| Type of method | Method No. | FIG. No. |
|---|---|---|
| Basic picture messaging | 7 | — |
| Method for sending a picture without Grades, | 8 | 3 |
| in real time, from a real time source | | |
| Method for sending a picture without Grades, | 9 | 4 |
| in real time, from a storage source a2. | | |
| Method for sending a picture with Grades, | 10 | 5 |
| in real time, from a real time source, b1. | | |
| Method for bandwidth management | 11 | 18 |
| Method for sending a picture with Grades, | 12 | 6 |
| in real time, from a storage source. b2. | | |
| Method for sending a picture without Grades, | 13 | 7 |
| not in real time. c1. | | |
| Method for sending a picture with Grades, | 14 | 8 |
| not in real time. c2. | | |

FIG. 3 details, in flow chart form, a method for sending a picture fast, spontaneously, without Grades, in real time, from a real time source.

Applications: A user takes a photo and desires to share it now with someone else. (a1.)

### Method 8—Picture Messaging

The method includes:

a. input picture: select picture, by communicating directly with picture's source or by using other software/program/plugin to get picture, or a stream of pictures from a real time source. This may include selecting a real-time source, and one or more pictures originating from that source. [711]

b. display picture. [721] may include special screens and relevant info

c. edit it—intelligent, manual/automatic. Fast. Result: picture version PV.
Change picture to adapt to intended use, to convey my message and personality. the edited picture is my message to you.
Operators: Select area; enhance; censor, hide; reduce quality; visual manipulation/effects; encrypt (optional) [731]

d. MLS 741—Monitor, Manage, Log and Secure.

e. send (and optional save) it. Send in real time.
This is the purpose—to send it now. store version, backup.
Gatekeeper: monitor pictures sent in real time, protect privacy and law.
Send=to the other party. 751
No fairness check, no grades, no class, no access level setting.

Optional, support features—may be added.

End of method.

Examples: WebCam or Camera connected to a hardware device

(Or other source of stream of images), Cellular Phone, Digital Camera.

Includes Editing and Sending the picture outright.

### Notes

1. This method may be useful in order to perform minimal editing, or for users who prefer a Quick Edit and Send approach, without having to bother too much with numbers.

2. It is possible to just preview several versions created using various editing approaches (as defined in this invention), then the user can instantly choose which version to send. The user can also predefine what type of version to create according to the editing method.

3. The user can choose for example to send from an options menu:

High/Medium/Low Resolution photo.

Limit the number of pixels describing one or more areas.

Lower the number of pixels in absolute number or in percentage % for a specific area.

Hide one or more areas completely.

4. There may be two buttons, ( [symbol] Up) and ( [symbol] Down) to change the Quality instantly, without having to deal with numbers. This is a fast and intuitive method of processing a picture, with a minimal hassle to user.

5. After the editing is completed, the version of the photo can be sent. It can be saved as well, assuming there is enough place for storage. If the photo is already saved, only the changes can be saved, to save storage space while still allowing to access these versions.

6. A version (edited picture) may either contain the new picture, or a pointer to the original and a list of edit operations to be performed thereon to form the desired version.

The latter method may be much more efficient in terms of storage requirements. The former may be more secure, for it is more difficult for a would-be hacker to get to the original picture from a censored version, and new pictures can be accessed by other programs more easily, such as by using known picture formats, such as: gif, jpg, png etc.

A user may perform an intelligent edit of source photo, in real time, according to predefined criteria.

7. Optional: Security setting according to personal criteria.

Auto Limit High-Resolution photos and display warnings regarding such pictures. Send pictures using a secured protocol.

May use encryption (public/private), using keys directory, for privacy.

A picture is taken for a specific purpose, recipient. It is immediately encrypted with his key, thus protected from others. A picture may be encrypted on disk as well, along with password protection.

### Method 8B—Picture Messaging

The Method includes:
a. acquire picture.
b. edit it to create a new picture version.
c. attach info, directives, comments to whom is sent, date, location, address sent to (email, phone no.,) assign destination,
d. encrypt to make available only to intended destination (optional).
e. send it.
f. save version sent, for later reference or re-send if not arrived (optional).

Types of pictures: original; improved, enhanced; censored, reduced quality. encrypted. coarse, indicative of subject but low grade, can be left as indication of subject in contents—with the higher quality pictures versions being protected.

Two or more types may be combined as well (a picture may have more than one property/characteristic).

End of method.

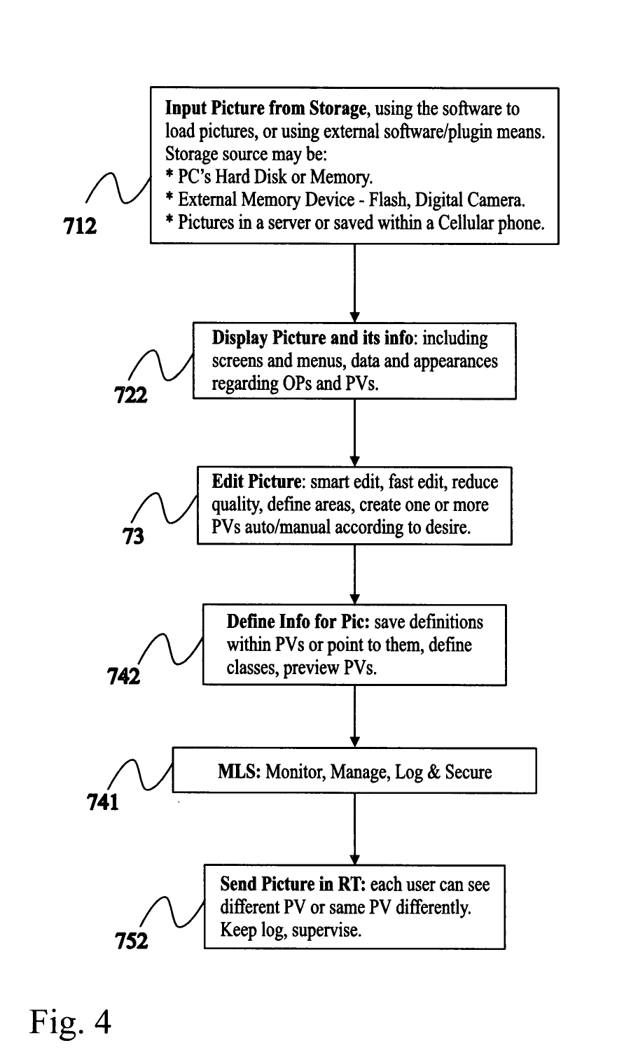

FIG. 4 details, in flow chart form, a method for sending a picture without

Grades, in real time, from a storage source. a2.

Application: The user talks or chats with someone, spontaneously decides to send a photo now, with or without editing.

Automatic log of sent files.

The Log may include and display when required: what have been sent/received to each person/recipient, keeping track of activities, results of checking fairness or mutual mode (either one with or without grades).

### Method 9—Picture Messaging

The method includes:

a. select picture or stream of pictures from a storage source 712.
picture=original or previous version;

This may include selecting one or more pictures stored there.

b. display picture and its info 722. The information for the picture may be computed automatically or may be set manually by the user. The information may include the Class.

c. edit it (optional)—intelligent, manual/automatic. result: picture version PV. 73
Change picture to adapt to intended use, to convey my message and personality. The edited picture is my message to you.
Operators: Select area; enhance; censor, hide; reduce quality;
   visual manipulation/effects; encrypt.

d. define info for picture: Class. optional. manual/automatic.
monitor info. info is not part of picture, only related, points to it.
Other info: comments, what is this, for what purpose, for whom.
Directions for others—to whom to show picture. info for us, to help us keep track of pictures, their editing, transmissions 742.

d2. MLS 741.

e. send (and optional save) it. Send in real time. 752
Automatic log of: to whom, what, when. Keep track of sent pictures.
This is the purpose—to send it now. store version, backup.
Gatekeeper: monitor pictures sent in real time, protect privacy and law.
Advise on fair/balanced disclosure with the other party.
Send=to other party.
Access level—may send different PVs according to A.L. of each addressee

Optional, support features—may be added.

End of method.

Examples: Wishing to instantly send photos or versions using Cellular Phone, Personal Computer, Server or Website.

The photos however are already saved, and maybe some versions are saved too.

Editing may be done, however if a saved version is acceptable for sending by the user, editing can be bypassed.

Sending photos or versions by the user.

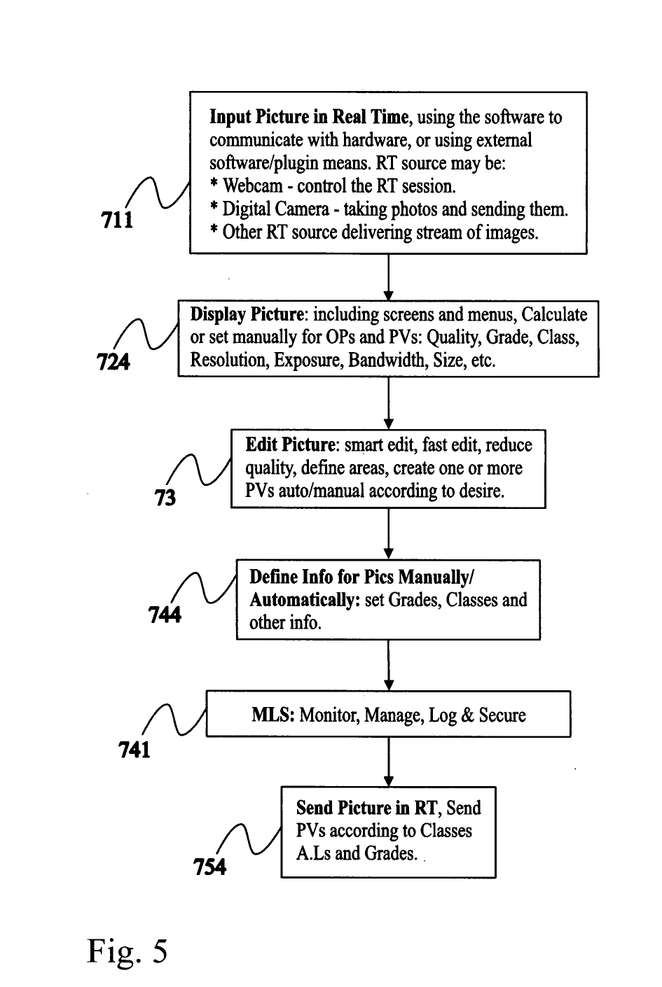

FIG. 5 details, in flow chart format, a method for sending a picture with Grades, in real time, from a real time source. b1.

Manages grades, access level for each recipient.

### Method 10—Picture Messaging

The method includes:

a. Input picture 711: select picture or stream of pictures from real time source.

b. display picture and its info 724. Compute info or set it manually to any of the following: Grade, Auto. Grade, Class, Required Bandwidth, Resolution, Exposure, Quality, Size.

Example: Define webcam only to be used with “friends” class.

c. edit it 73—intelligent, manual/automatic. result: picture version PV.
Change picture to adapt to intended use, to convey my message and personality. the edited picture is my message to you.
Operators: Select area; enhance; censor, hide; reduce and/or limit quality; visual manipulation/effects; encrypt; limit/allocate bandwidth; mutual mode and “see me while I see you”; Set general maximum limitations (such as maximum file size, quality, etc.)

d. define info for picture 744: Grade, Class. optional. manual/automatic. monitor info. info is not part of picture, only related, points to it.
Other info: comments, what is this, for what purpose, for whom.
Directions for others—to whom to show picture. info for us, to help us keep track of pictures, their editing, transmissions, where to store.

d2. MLS 741

e. send (and optional save) it 754. Send in real time.
This is the purpose—to send it now; store version, backup.
Gatekeeper: monitor pictures sent in real time, protect privacy and law.
Advise on fair/balanced disclosure with the other party.
Send=to other party.
Access level—Send PV according to A.L. for example low resolution PV for people with low A.L.

End of method.

Examples: WebCam (Or other source of stream of images), Cellular Phone, Digital Camera.

Any of the following can be used:

Limit Access—According to Access level and Classes Access assigned to each recipient of photos.

Security—Prevent from sending, or adjust photos or versions as defined, monitored in real time according to this method, such as by a TSR, or by a Java applet running on the user's computer and notifying a server which delivers media to people according to their access levels and Classes Access.

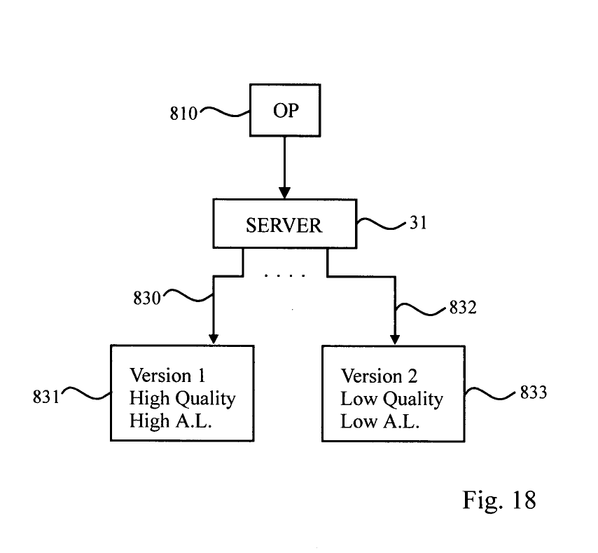

FIG. 18 details a method for bandwidth management.

### Method 11—Bandwidth Management

The method includes:

a. A user can send Original Picture OP or PV 810 to the server 31, or manage it directly from PC, cellular etc. to others, through the server.

b. The server can then send different PVs as defined by the user, such as Version 1 of PV 831 with higher grade, higher quality and taking more bandwidth 830 to transfer, for a person with a higher A.L.

c. The server can also send using communication resources, such as Version 2 PV 833 with a lower grade, lower quality and taking less bandwidth 832 to transfer, for a person with lower A.L.

d. When using webcam, bandwidth can be saved by sending PVs with lower quality or with less information, which would demand less bandwidth.

The quality, resolution, size or amount of information in the PV can be reduced by automatic editing, or even by manually blocking some areas which will not be sent.

e. The bandwidth can be managed automatically, preferably when each person has A.L. and the bandwidth is defined by that. The user can also decide the bandwidth or PV or A.L. in real time, resulting in a smaller bandwidth usage.

f. In case of cellular phone, even when sending few photos, pricing and time for sending could be dramatically reduced by using editing methods.

g. Sometimes only the difference or additions between a current and a new PV can be sent, thus saving in the amount of data to be sent to each recipient.

h. Sending is more secure and faster, due to the overall management of PVs, bandwidth and/or automatic features.

End of method.

### Notes

1. A Server may allow for faster sending of the precise content as desired for each recipient, since it has a larger bandwidth.

2. The User may change Grades, Classes and Access Levels in real time, as well as the Security definitions. Example: Not to show the eyes to anyone.

3. The Program may also monitor movement and follow the location of defined areas.

Sending is done in real time, and allowing sending to more than one user where each person can receive a different version/PV.

4. Method stages: acquire picture. edit it. assign grade. assign destination, make available or adjust only to intended destination. save one or more versions. encrypt if required. send it.

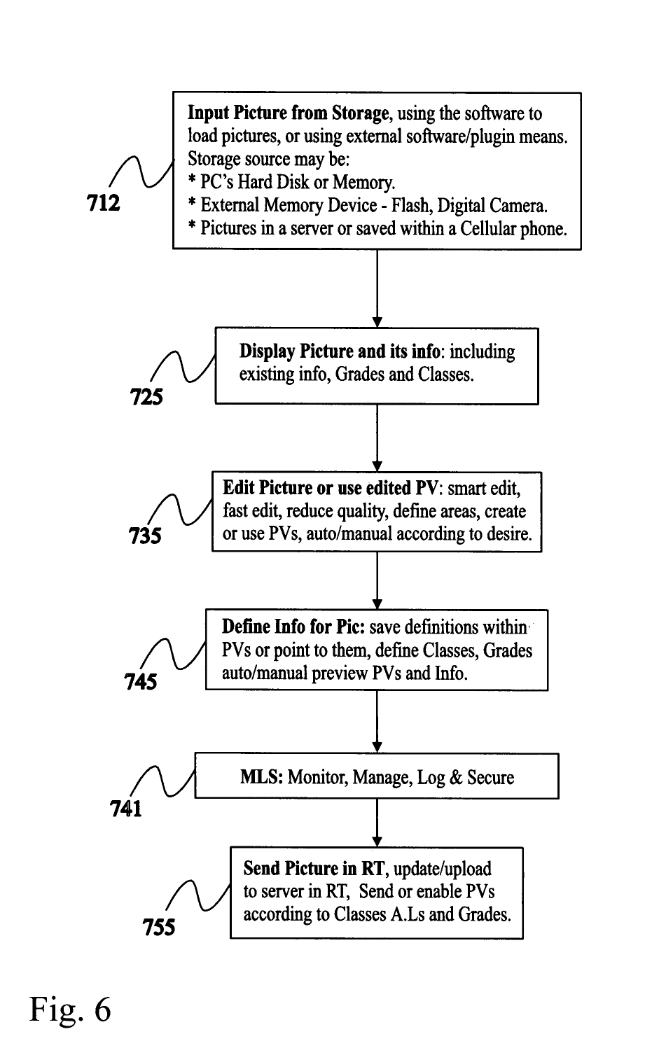

FIG. 6 details, in flow chart format, a method for sending a picture with Grades, in real time, from a storage source. b2.

Application: Sends picture with grade and class. Can change access level for recipients, in real time. The system checks if access level corresponds to grade and if not, it can: warn the user, not send PV (block it), adjust PV (edit), block access. If access level does correspond to grade: update server, send PV, update PV, Log and/or perform other MLS operations.

### Method 12—Picture Messaging

The method includes:

a. select picture or define from a storage source 712.
picture=original or previous version or PV;

This may include selecting one or more pictures stored there.

Browse pictures easily, such as sorting by: Quality, Grades and/or Classes.

b. display picture and its info 725. i.e. Grade, Class (may be previously defined).

c. edit—if required, or open a ready-to-send PV. Edit 735 includes—intelligent, manual/automatic. Result: picture version PV.
Change picture to adapt to intended use, to convey my message and personality. the edited picture is my message to you.
Operators: Select area; enhance; censor, hide; reduce quality;
visual manipulation/effects; encrypt—if defined and supported for current PV.

d. define info for picture 745: Grade, Class. optional. manual/automatic.
Monitor info. info—can be within picture file, or related, pointing to it.
Other info: comments, what is this, for what purpose, for whom.
Directions for others—to whom to show picture. info for us, to help us keep track of pictures, their editing, transmissions, MLS 741

e. send (and optional save) it 755. Send in real time, or update server
to grant access/update A.L./update Grades, update class info at server in RT, etc.
This is the purpose—to send it now or enable sending. store version, backup.
Gatekeeper: monitor pictures sent in real time, protect privacy and law.
Advise on fair/balanced disclosure with the other party.
Send=to other party.
   Access level setting.

End of method.

Examples: To instantly send photos or versions using Cellular Phone, Personal Computer, Server or Website.

The photos however are already saved, and maybe some versions are saved too.

### Notes

1. Editing may be done, however if an existing PV or saved version is acceptable for sending by the user, editing can be bypassed.

2. The user can change in real time the access level or classes access for a recipient thus overriding prior settings in the system, to give them instant access to photos or send them the photos.

3. The user can send photos or versions either directly, or indirectly by enabling access through other means, or using other means such as WAP compatible hardware for sending edited PVs from cellular phones to PCs and other people.

4. Security means may be used.

5. In a simple approach, the user can monitor the access level of all the people and change them. As an access level or class access are changed and if security means approve this, immediate access to photos or versions is granted. This allows useful management and delivering of different photos and versions to a any number of people.

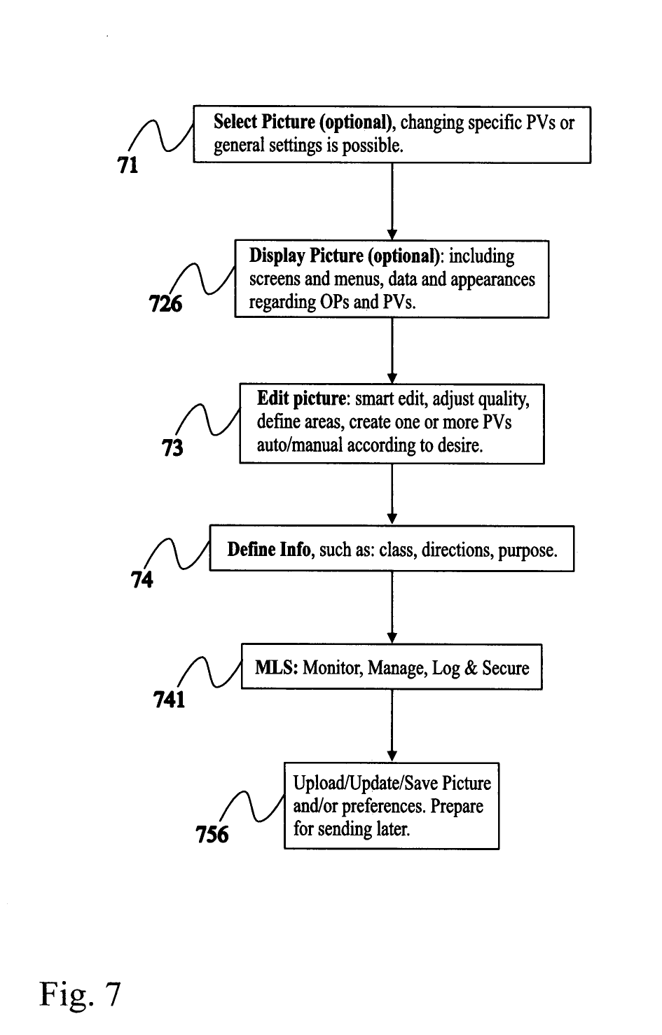

FIG. 7 details, in flow chart format, a method for sending a picture without Grades, not in real time. c1.

Application: Distribute pictures through a server or place pictures in one's own PC where they are available to others according to predefined criteria. For example: a PC for dating services, matching, helping people to meet each other.

The method may be used to enforce a mutual, fair exchange of photos of similar quality among users.

That is, will keep the score of pictures exchanged and will guide the users to perform a fair exchange.

Such as a long term dialogue by email may be easily performed among users, wherein each user may use edit, Log and/or MLS for sending PVs. The users may decide to improve PVs slightly/gradually with each transmission, for example by increasing the Resolution, Quality and/or Exposure of pictures sent.

### Method 13—Picture Messaging

The method includes:

a. select picture or stream of pictures 71. This is optional: in case only changing definitions, such as MLS or watching log is required, then no pictures need be opened.

b. display picture and its info 726 (optional).

c. edit it 73—intelligent, manual/automatic. result: picture version PV.
Change picture to adapt to intended use, to convey my message and personality. the edited picture is my message to you.
Operators: Select area; enhance; censor, hide; reduce quality; visual manipulation/effects; encrypt—optional so that others cannot see files in user's PC.

d. define info for picture 74 such as Class. optional. manual/automatic. monitor info.
Other info: comments, what is this, for what purpose, for whom.
Directions for others—to whom to show picture. info for us, to help us keep track of pictures define and set or save PV, their editing, transmissions, MLS 741.

e. upload and/or save and/or update preferences (such as class, exposure and quality limitations) for PV 756.

Prepare for sending later. The goal is to send or enable sending it later.

Store version, backup.

Smart editing of images, defining and previewing areas with different resolutions or controlling number of pixels for areas, can be preferably used.

Photo or PV can be saved or defined, for example: webcam defined with full screen and max. resolution.)

Different versions PVs can be further created (Saved or Defined) from existing definitions such as from webcam definition.

Fast and easy previewing and sending of the versions is possible, in this case this may be done by email or by enabling access for PV.

Fast and easy editing, such as telling the software to reduce quality of an area, or of the whole photo, by pressing simple buttons, this is more useful while sending in RT, but it may dramatically reduce the time it takes for the user to create PVs in this method as well.

End of method.

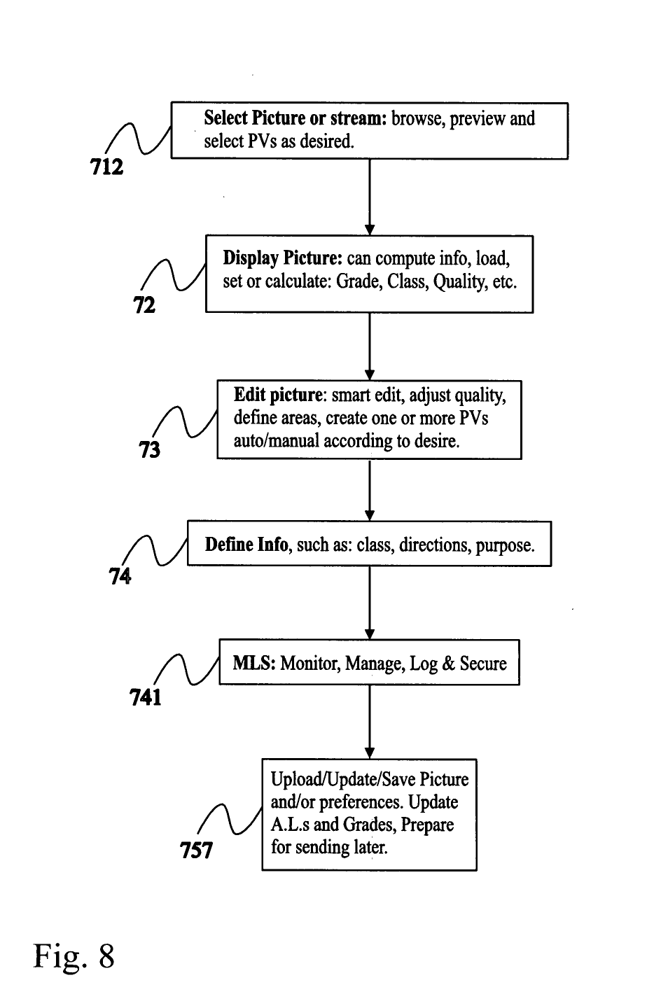

FIG. 8 details, in flow chart format, a method for sending a picture with Grades, not in real time. c2.

Application: prepares and stores picture versions, for later use.

A user can change or update existing versions as the need be.

### Method 14—Picture Messaging

The method includes:

a. select picture or stream of pictures 712.

b. display picture and its info 72. If no previous info—can compute it or set it manually—i.e. Grade, Class, Quality, etc.

c. edit it 73—intelligent, manual/automatic. result: one or more picture versions PVs.
Change picture to adapt to intended use, to convey my message and personality. the edited picture is my message to you.
Operators: Select area; enhance; censor, hide; reduce quality (such as by a predefined percentage, limit by number, or choose “lower”—to be done automatically).
visual manipulation/effects.
encryption if required and possible.

d. define info for picture 74: Grade, Class. optional. manual/automatic.
monitor info. info is not part of picture, only related, points to it.
Other info: comments, what is this, for what purpose, for whom.
Directions for others—to whom to show picture. Info for us, to help us keep track of pictures, their editing, transmissions, MLS 741.

e. Upload and/or save and/or update preferences (such as grade, class, exposure and quality limitations) for PV 757. prepare for sending later, or send using non real time means, such as email. The purpose is to send it, now or later. store version, backup.

It is also possible to update A.L. of other people so that they could have access to PVs, such as A.L. in a server or in a PC.

Gatekeeper: monitor pictures and activities in real time, protect privacy and law.

Advise on fair/balanced disclosure with the other party.

Send=to other party, or upload to a server or other device.

End of method.

### Notes

1. The user can use smart edit anytime.

2. The user can control A.L. (valid when are defined) of others anytime.

3. The user can manage PVs, pics anytime.

4. The user can change definitions anytime, for example:
The maximum grade—max. Gr. of PV which can be sent, PVs with higher grade will be blocked.
Define mutual mode with any person/recipient, and define or change mutual mode settings.
Limit maximum Quality—the max. Quality of PV or of relevant areas which can be sent, PVs with higher quality can be edited to match the Quality limit criteria.
Define limitations for each grade (valid when are defined)—allows the user to easily set limitations just by setting a grade to PV.
Define Classes—allows users to easily manage PVs and better secure and monitor groups versus people as desired.
Define when to use encryptions—this can be easily set, such as encrypt automatically on disk and/or while sending PVs with high grade or which belong to certain classes.
Define when to block, edit automatically and/or ask for password—this can be easily set, such as block automatically PVs for sending with high grade, reduce grade such as by reducing quality for some PVs, and optionally ask for a password, such as for encrypted PVs or while trying to send PVs which belong to certain classes.

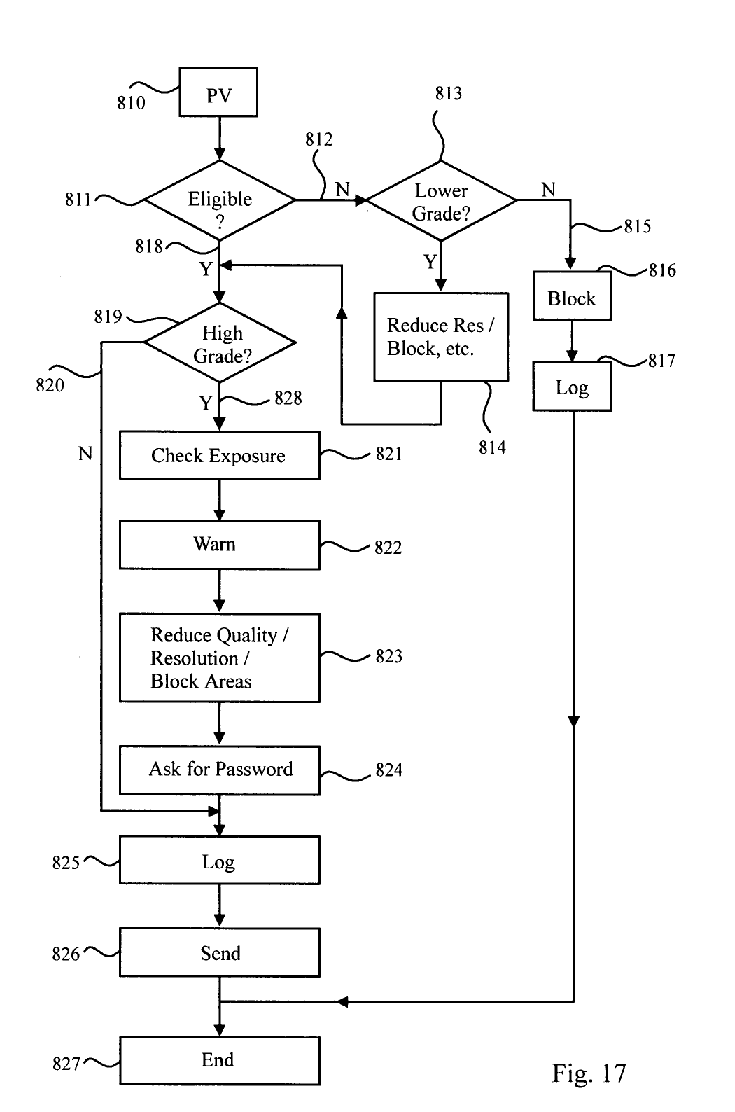

FIG. 17 describes a possible flow chart for sending a PV.

In a preferred embodiment, some of the operations may be implemented within the MLS.

Method 15—Picture Processing with MLS

The method includes:

a. As the user wishes to send a PV or any picture 810 which was just made, or which is already stored, the LMS mechanism will check whether it is allowed to send it, and can take additional steps before sending it, or may prevent it from being sent. This can also be initiated in real time, while supervising and checking stream of images coming from the webcam, for example.

b. Verifying whether the intended recipient is eligible to a specific photo can be implemented by checking in definitions 811 of PV, what are the grade and class (if defined), quality, exposure, file size.

Such definitions, computations and decisions may be performed in real time.

c. Preferably, these definitions are pre-defined when Managing the PV.

In cases such as communicating in real-time with others and the PV was just made such as in a digital camera, webcam or cellular phone with a camera—then details can be calculated automatically in real time if the hardware and/or software support these features. The results may then be presented to the user. This can be part of the “Manage” operation in LMS.

According to the definitions, mode of operation and the attributes of the PV, it may be decided whether the other person is eligible to receive that PV.

d. In case the intended recipient is not eligible 812, a Lower Grade approach 813 is initiated, but only in case it is allowed according to preferences and a user's decision—the user has indicated in advance this is allowed.

e. In case it is permitted to Lower Grade, either by asking the user in real-time, or according to preset preferences, the PV can be manipulated, edited or replaced with other PV 814, so as to become eligible for that person. This can also be done automatically, as was defined by the user.

f. The new PV can also be presented to the user so he can decide himself whether the modified PV is eligible to be sent to the other person. This embodiment is not fully automatic, since it requires personal decisions to be made by the user.

Thus, the present method is powerful and flexible—it allows to define in advance what to do in any case, and the measure of sender's personal intervention in each case.

g. In case a Lower Grade approach is not allowed 815, the PV is blocked 816 from being sent, Log 817 is updated as well as the user.

h. In case the recipient is eligible 818, any of the following can be verified 819:
1. PV has high grade—either as a constant limit or according to the other's A.L. or according to other limitations as user defined.
2. PV has high resolution—or high quality, according to definitions of these parameters.
3. PV reveals high exposure—such as high resolution or too many pixels in private areas as defined, or a mixture such as high exposure of both face and body.
4. File Size can be checked or be a factor as well.

i. If the PV does not have high grade or equivalent 820, then the operation's details are kept in the log 825 and the PV is sent 826.

k. If the PV has high grade or equivalent 828, then various steps can be taken:

The user may be asked for a password, may receive a warning, etc. 822 according to what was defined for that scenario and PV.

In case only the Grade or Quality were checked, the level of Exposure can be calculated too, such as number of pixels in private areas, whether the body is exposed, and if so what parts and whether the face are exposed too.

The user can prefer to only reveal specific body areas to some people, while revealing other areas to others. This can also be implemented by using classes. If such a definition is set, then a PV revealing the face, for example, will not be accidentally sent to someone who is not allowed to receive that PV.

m. Any of the abovementioned can be implemented either automatically or manually 823, using editing techniques as described in this invention.

The user may be asked for a password, such as in case the PV is encrypted or protected, the PV has high grade, the user defined to ask for password for current PV/class/Grade/Directory, a scenario was defined for asking for password (such as time of the day or according to the person to which this PV should be send).

n. The PV can then be sent 826, and the data is logged 825 similarly to other cases. The method ends for current PV 827, however several methods can be operated at the same time for different PVs.

End of method.

3. Editing of personal pictures

The user may prepare picture versions (PVs) from an original picture. This may include:

a. Input pictures: photographs and/or streams of images, in digital format.

b. Data storage (optional); or: input, edit and send direct without storage.

c. Display and Edit the picture. Purpose:
1) improve picture, correct blemishes, retouch
2) reduce quality, reduce resolution, cover/hide/block part of it, distort it, mix parts of it, smear like in motion. use picture processing effects, filters, color selective processing

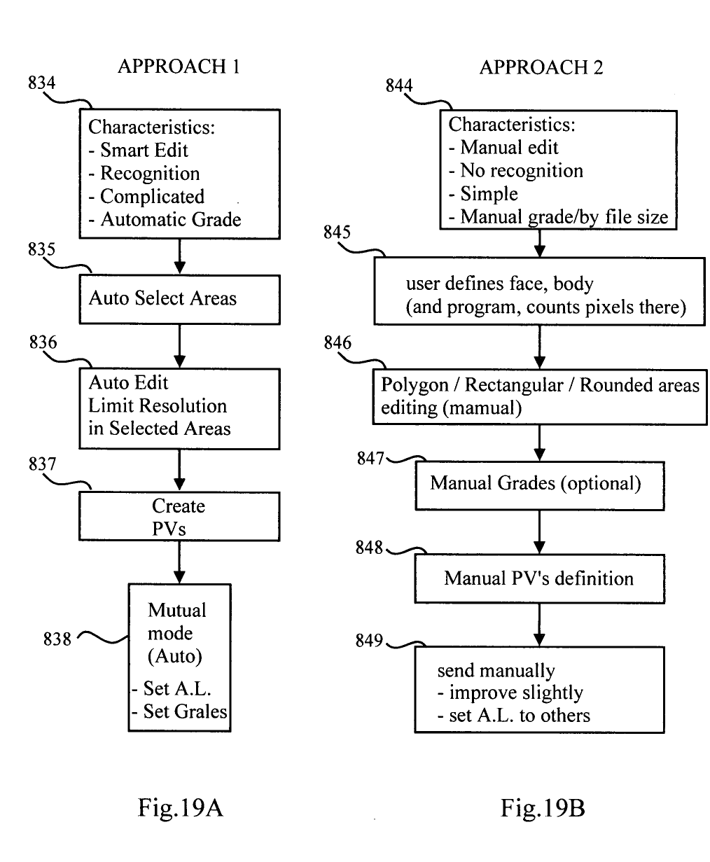

FIGS. 19a and 19b illustrate a relatively complex and a relatively simple implementation, respectively.

Two general approaches are compared:

1. Smart editing including automatic recognition of parts/areas in PV and relatively complicated automatic image operations 834. This requires more software and/or hardware resources.

This approach shall be referred as “Approach 1”.

2. Simple manual editing without recognition of parts/areas in PV and relatively simple image operations 844. This requires less software and/or hardware resources. This approach shall be referred as “Approach 2”.

### Method 16—Smart/Simple Picture Processing

The method includes:

a. Grade: In Approach 1, automatic Grade can be calculated, such as by taking into account: the number of pixels in the face, number of pixels in the body, the amount of exposure such as exposed body parts, etc.

In Approach 2, the user may decide on the value of the Grade, or the Grade can be calculated according to file size.

The user can mark areas on screen and the software could then count the number of pixels in these areas, to calculate the grade with higher accuracy.

b. In case a grade is required it might take longer and require more work from the user in Approach 2. While working in real time, automatic grade could be more useful.

c. In case of working off-line on PVs in storage, the user can efficiently define grades manually 847, and use data such as automatic grade and number of pixels in different areas as recommendations for grades of different PVs. Manual grades can be given in Approach 1 as well.

d. Areas: In Approach 1 areas can be identified 835 more easily, such as recognizing different area parts in the face and body. In Approach 2 polygons, circles, ellipses etc. can be drawn by the user above the PV in order to define 845 areas.

In both Approaches, different editing operations can then be initiated on these areas.

e. Picture Versions: PVs can be created automatically in both Approaches, however it is more likely that it is used in Approach 1, since “nose”, “mouse”, “legs” and any other areas can be defined 836 automatically, and the user can control the creation of many PVs 837 more easily. In Approach 2, each area should be defined 846, hence there may be less areas defined or maybe the user would create 848 each PV from scratch, and will probably create less PVs.

f. In addition, it is easier to calculate the grades of the newly created

PVs, and define classes for them (such as a class in which the face are revealed) in Approach 1—automatically and more accurately than in Approach 2.

g. Sending: It is more likely that, in Approach 1, mutual mode 838 will be used, supporting other automatic features, and since there are probably several PVs or definitions for grades of each PV, according to granted A.L. to others, thus it can be easier to manage mutual mode in Approach 1.

In Approach 2, it is possible that each PV was created with more consideration and it took more time, the user would prefer sending 849 it manually and with more consideration/deliberation.

h. In both Approaches, it is possible to set grades and A.L., improve the PV sent slightly to allow the other person seeing a bit more and control resolution and editing features of each are of the PVs.

End of method.

### Notes

1. Various effects may be implemented while editing the photo, to make it look better, such as: smoothing, noise reducing, illumination and alpha correcting.

2. Various effects and editing may be done, and defined, either in real time when communicating with someone, or off-line or in any other time. These effects may include: hiding, reducing the resolution, reducing illumination or other digital effects or a combination thereof.

3. The various effects may be selectively applied, each to only a part or a predefined area of the photo.

The user may define each effect and the area to be affected thereof. Similarly, several such effects may be implemented for different parts or areas of the photo, or for the whole photo.

Thus, in part of the photo the resolution may be reduced, in another part—the resolution may be lower still, yet another part is censored (blacked out) altogether, etc.

4. Tracking a predefined area in the picture as it moves to another location. For example, if the area is the eyes of a person then, as the person moves his head with respect to the camera, the location of his eyes will change. The system may automatically track the eyes area to its new location.

Moreover, if the person gets closer or farther away and the size of the eyes changes, the system will adapt accordingly. The user's face may rotate sideways, etc. Using correlation techniques for example, the system may process such changes in the picture to track the location of the selected area.

The desired operator will be applied to the area tracked as detailed. Thus, if the eyes location changes and the area changes in size, the eyes may be still presented at a reduced resolution—such as by limiting the maximum pixels of the eyes in PV (as defined for quality), or blocked completely, as set.

5. According to the grade, the user may define what each other could see, for example granting access only to certain people, or to trusted ones. In addition it could be defined, either manually or automatically by the software, how the effects 3C should be used, so that to allow others with lower access to view photos with higher grade.

### Method 17—Display and Edit the Picture

Purpose:

1) improve picture, correct blemishes, retouch

2) reduce quality, reduce resolution, cover/hide/block part of it, distort it, mix parts of it, smear like in motion. Use picture processing effects, filters, color selective processing.

Limit the size, bandwidth, quality, resolution criteria, limit maximum number of pixels in an area.

3) decide who can see it.

How to do it:

a. Display picture or PVs and their info, edit one or more PVs, define grade, class and any other characteristics as required.

b. choose area (part of picture) to display/edit/transmit. Optional.

Manual—user selects part of the picture—rectangle, circle or other shape Automatic—Software may automatically choose area of body according to user's commands: choose head, face, eye, lips, nose, hands, foot, etc.

c. Picture signal processing: change resolution, improve appearance, change colors, compression with various parameters.

d. attach a grade (number) to each picture or desired PV resulting from the above processing, to control access permission—who is allowed to see it.

The result=Net picture version N-PV; public picture version P-PV output picture version O-PV

e. Each acquired picture may results in many picture versions PVs, each with a different area selection, picture signal processing and assigned grade. Grade definition: manual or automatic. Automatic: according to predefined criteria, such as size of file, resolution, number of pixels in the face. Pixels in face—is significant; otherwise may fake it, large picture with lots of background but small face, few personal details.

f. Can change grade in real time, as user moves his/her face closer to or farther away from a web cam. Thus, the resolution can be changed automatically; edit can be done automatically in real-time, so that PV stays with a fixed grade.

End of method.

4. Managing Communications with Pictures

This may include:

1. Transmissions management: Keeping track of messages sent/received—what data; to whom (recipient); when; parameters/characteristics.

2. Management of sent pictures. keep track of sending, what version, to whom, preferably use MLS.

3. Define/compute communications parameters

Changing grades of photos or versions, at a server accessible to others, such as in a website for dating, others can view PVs according to their access levels when they wish to.

Changing access levels of others, for example to an account in a website or to the user's photos at his PC.

Different people with different A.L. could see same PV differently according to their A.L. by applying picture editing during the presentation to each person.

4. Changing or creating Classes definitions. Defining types of PVs, exposure, size, directories, source (such as webcam preferences), etc.

5. Changing MLS definitions, changing security definitions for photos in the PC, or changing photo management definitions while being offline, or while others are offline.

6. A slow mutual mode—in which photos and versions are exchanged in a slow manner, for example by emails, or without replying immediately in RT, then the program notifies the user that a new version arrived from the other person, and if the user approves, then a new version will be sent back to that person, this is especially useful for slightly improving sent PV each time, or sending a slightly better one, as a gesture.

7. Calculating Quality automatically or definitions by the user, using Image Recognition in order to:
define areas and edit them,
Count number of pixels within an area for grade, for limiting max. number for calculating grade, etc.

8. Defining grades, defining different versions and classes to the same photo, for example by creating a new PV according to limitations.

9. Define and grant access

An access level could be defined to others, allowing matching the grade of each photo, with or without effects, so that people with lower access level could only see low resolution photos for example, while friends which were granted with higher access level by the user, could see higher resolution photos, for example. The access levels are controlled by the user, and may be changed by him for each person, for example giving a higher access level to someone who gave higher resolution photo for the user.

### Method 18—Monitor, Log and Secure (MLS)

This is the block 741 mentioned elsewhere in a systems context.

MLS is preferably initiated after editing (if performed) and before sending or transferring pictures.

These functions may be performed in PC or in a Server, or coordinated between two or more units as need be.

Following is a description of each function:

a. Monitor

The system monitors activities performed, detects in real time any unauthorized or forbidden activity such as trying to send:

1) Pic with too high grade (if it has a grade)

2) Pic to someone with Low A.L.

3) Pic which belongs to a private class, or irrelevant class to this person.
(Example: Pic from the sea, for friends, to someone belongs to work class.)

4) Pic which usually is not sent in this time of the day.

5) Pic which should be sent to someone with which the user did not make any contact, such as to unknown IP address.

6) Pic with high Quality, Pic with High Resolution or a Pic which is a big file, and thus is probably private.

7) Pic in a directory which was defined as a private pics directory.

8) Pic to someone who already accepted too many pics, or trying to send a pic violating any term such as of fairness method, or a mutual mode.

b. Log

Logs (records) what was already sent and to whom, in order to provide this info to the user and software, and to block as would be required. Log the quality, resolution, sort of versions, and any relevant data, of pics and versions to allow immediate response according to that data.

The quality, resolution, etc., can be calculated automatically.

c. Secure

Includes steps that can be taken when detecting an unauthorized/forbidden attempted transmission of a picture:

1) Demand password from sender.

2) Block or limit Quality or resolution automatically (especially in case the user grants A.L. to people in Real Time and does not want to start setting definitions).

3) Demand pic or password, etc. from the person on the other side.

4) Send alternative which matches limits, for example by reducing resolution and/or quality in certain areas or in the whole pic automatically.

5) Demand from the user to take action, such as reduce resolution/quality/size of file/hide areas, etc.

6) Ask for user permission, of from a password from the user, to ensure he approves this operation.

7) Encrypt, or send using secure protocol, etc. in case it is required for that kind of pic.

d. Manage (Optional)

This function, if present, may be performed anytime or as defined.

e. Definitions Setting (Optional)

The Definitions may be set up anytime. Usually, the definitions already pre-installed and can be password-protected.

Either online or offline, set limitations for sending, such as hours of the day, private classes, display warning and ask for permission or password from the user before sending pics with high resolution/quality, or files in a certain size, etc.

Quality may be calculated automatically as well, for example by defining the number of pixels of the face, number of pixels of body, or number of pixels in exposed private areas.

It is possible to define grades and classes, either manually by the user, automatically by the software, both (for more security), or by overriding some automatic grades manually by the user.

User may define how to handle bandwidth, rate of transfer, resolution, quality, versions, etc. to each kind of person/recipient of photos, which will apply when he is online, for example when he will use a webcam:

Version 1—to anyone, update each 2 seconds block eyes and limit resolution to 20000 pixels in face.

Version 2—to someone who already was approved or currently approved, update each second block eyes and limit resolution to 30000 pixels in face.

Version 3—to someone who already is exclusively approved, update each second do not block and do not limit resolution.

End of method.

### Method 19—Deliver Photos/Streams to Each Person

a. Photos may be sent through any communication mean or source. Thus, photos may be sent in real time by the user, alternatively they also may be saved in order to be sent by the user as desired, for example by e-mail, through other software, in order to be printed, etc.

b. In order to send the photos in real time, the IP address may be presented to the user by the software, so that he could tell other people to what IP address to send photos, allowing the software communicate with other copies of the software at other computers.

c. In case of cellular phones, a phones number can be given. Alternatively, any kind of informative data may be given, in order to allow efficient communication, such as email, through an Internet site with a user name, etc.

In one implementation, a system is implemented using a web interface where the photos of the user may be kept in the server, however the user may control which photos and at what resolution are shown to each person.

d. While chatting with other persons through a server, the user may grant access in real time to his photos as wished. Thus, the user may have an account at a web site, for example, allowing him to tell others to see his photos through that account and then grant access to each person as desired. The user may chat with other persons through this web site, or by other means, and then tell each of them to see his photos through that particular site.

e. In another implementation, the user may chat and reveal areas of a photo in real time, such as only showing the eyes, or any other part or area of the body. In this way it is easier to reveal only some details and control how much is revealed easily. It is also easier to stay anonymous, thus increasing the safety of the user.

f. It is possible not to define grades and access levels. Rather, one can decide what to show or what to send to each person in real time. For example, using a software with editing tools which allows to select and define areas either automatically by the software recognizing “the eyes” for example, or manually by the user, then it is possible to send the photo. This allows showing a particular area or a photo quickly and easily in real time without setting definitions. The resolution in general, or for a particular area, can be set and defined as well.

g. It is possible to grant access for a person quickly, simply by pressing a button or defining that user. This can be done easily after grades were already defined for various photos once. Then, according to the access level a person is granted by the user, some PVs will be made available to that person. It is also possible that, even though some photos may have a low grade, they would still not be shown to anyone having the required access level, to prevent people from seeing photos in subjects/areas of activity to which they are not privileged.

h. It is also possible to limit the number of pics according to the A.L. or other criteria.

i. Such subjects/areas of interest are defined in this invention as Classes. By creating classes and assigning pictures and people each to one class, it is possible to limit access to pictures based on two criteria: both Grade and Class.

Only a person belonging to that Class (or subclass if permitted) and having (at least) the required Grade can see a specific picture.

j. The grades/classes method present one approach/embodiment of the present invention relating to granting selective access to one's pictures. Other methods for giving selective/preferential access to photos could be used as well as implementations of the scope and spirit of the present invention as herein detailed.

End of method.

### Method 20—Manage Mutual Mode Exchanges

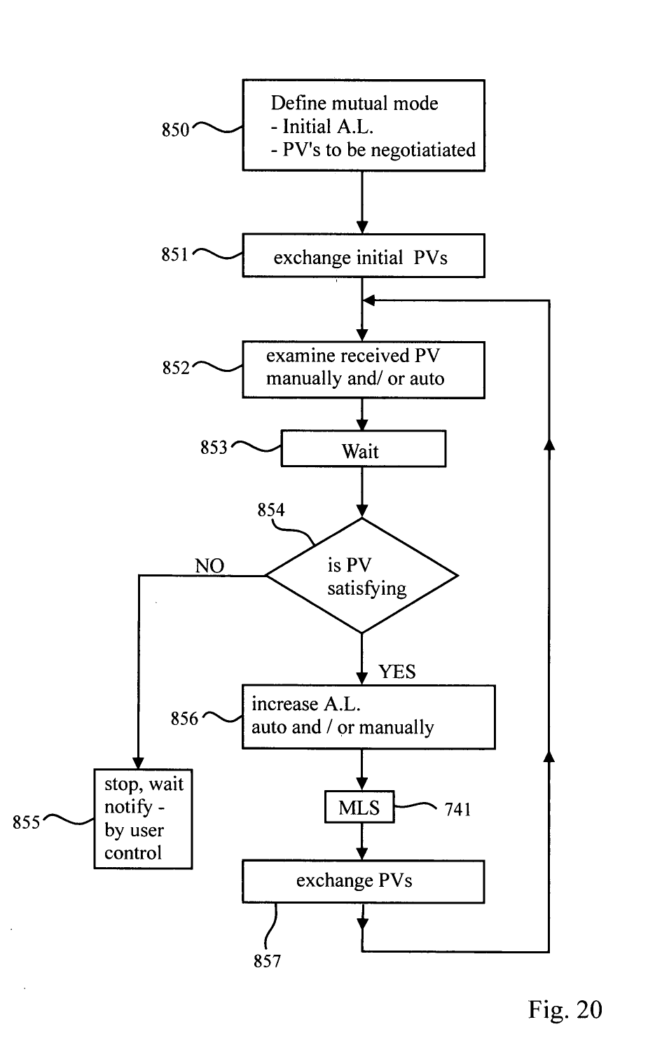

FIG. 20 illustrates one embodiment of a flow chart for initiating a mutual mode.

a. Define mutual mode 850—the user enables this mode for a certain person.

General initial parameters may include:

b. Initial A.L.—the initial access level this person would have to PVs, e.g. the person may already have this A.L. or it may be defined.

Max. A.L.—the maximal access level this person can possibly have to PVs, to prevent a situation in which the person accidentally reaches too high an A.L.

c. PVs to be negotiated—only PVs from that list could be revealed, and not any other, this may also be implemented using classes, but it can be safer for the user to exclusively define PVs that could be shown to that person in advance.

d. Increase by default—if, after receiving a PV of the other person wishing to grant that person a higher A.L. easily by clicking one button, then the increase in A.L. can be performed according to this value. It can also be a function of the quality of the PVs which were received from that person and it can also be controlled and decided manually by the user.

e. Initial PVs are exchanged 851, according to initial definitions or according to user's desire or in a some sort of fair manner such as by having a judging server which compares PVs and then automatically lowers one PV's quality to match the other, then send the PVs to each party.

f. Each side then examines 852 the PVs which was received, using automatic means and/or manual means and/or a mixture, for example the user can mark relevant areas and the software will then count the number of pixels in these areas, to calculate an overall grade.

In general, received PV can be tested similarly to user's options for calculating grades, this may include: Quality, Resolution, File Size, Exposure, Manual checking etc.

Thus, the user can compare sent PVs with received PVs, and decide (or set the software to do so) what to do accordingly, for example to increase quality by 10 percent increments, relatively to the last PV the other side sent.

g. Wait 853—each progress in the mutual mode can take any period of time, for example the user may decide not to send a new PV for now, or to set the software to remind him about this option within some period of time, such as one hour, a day, a week, never, etc.

During this time, the other side may ask for a new PV, or the user may decide whenever he wishes to proceed from last stop and send a new PV. The user may also see the history and log.

h. When a PV is received, the user and/or software and/or hardware should decide whether it is satisfactory 854. This can be done by checking whether its quality is better in at least 10 percent relatively to last received PV from that person, looking at the PV by the user which decides whether its quality is acceptable, and whether he is interested in going on with the mutual mode with that person. The user and/or system may use any data which is described in this invention for making this decision (such as grade, exposure, quality, etc.)

i. The decision can be postponed as well, to a later date, or the user may ask the system to remind him, within five minutes or seven days, for example, to decide what to do with that person.

j. In case the user is not satisfied with a PV which is later received or wishes not to continue from any reason, he may stop the mutual mode 855, and log this so as not to forget he is not interested in mutual mode with that person. He may also enter a reason so that the program would automatically remind him that, in case the user accidentally tries to restart a mutual mode with that person.

k. In case the user is satisfied with a received PV, the mutual mode may continue. The user can send a new PV or increase A.L. or reveal more details in current PV 856, etc. This may be done manually or automatically using the what was predefined. Thus, the user can simply click one button in order to easily grant more access to the other person and proceed with the mutual mode.

l. MLS 741—Manage, Monitor, Log, secure; it can be combined in this mode of operation in order to supervise, keep details and prevent from accidentally sending private PVs, etc.

m. PVs are then exchanged 857, and the procedure returns to the examining point, again the user may decide to stop or continue.

n. The user may initiate the mutual mode even if the other side does not, this simply helps the user to manage progress of PVs negotiated with that person, and demand better PVs each time.

o. Visual menus can be used to easily show the grade, A.L. and the quality and calculated grade of received PVs, so that the user may easily monitor and compare what was send to, with what was received from that person.

End of method.

### Notes

1. A mutual mode can be enabled and monitored by the user. In this case, the photo, PVs, Stream etc. which will be sent will be in the same or about the same or in a fair manner quality (such as the number of pixels describing the face) as the photo, PVs, Stream, etc., as received from that person.

2. The calculation of quality can be implemented by a software or other method in accordance to this invention. Defining the quality of the photo can also allow giving grades fast and automatically to the photos of the user, thus saving him the need to do so manually, as desired.

For example, if a webcam is connected using the software according to this method, and a special image quality or A.L. is defined for a certain person then, if the user would get near the webcam, the software program would decrease the resolution, according to the quality defined.

In that way the user can reveal himself in a webcam without being exposed or identified by other persons which do not have high access.

Also, bandwidth is saved and can be defined or limited in advance.

3. In a cellular phone, it is possible either to take a photograph, to open a photo which was received from elsewhere or a photo that has been previously saved in the cellular phone.

It is then possible to easily edit the photo from the phone, to define or calculate automatically its quality, allowing to exchange it with others easily. This could be useful for example when wishing to send a low resolution photo of the user to a virtual friend, just showing or blocking a specific area of the body or of the face, etc.

4. In addition, it is possible to send a photo with higher resolution of the face and lower resolution of the body in order to better see the user, saving limited bandwidth and hardware (such as memory for the photos) of the cellular phone at the same time.

5. It is possible to use digital cameras similarly, to exchange photos using any means, such as connecting through a USB channel and sending the edited photos by email.

In such cases, the method of this invention is useful in easy and instant editing of the photos and then sending them, without using complicated software, a computer, or other means, but using only direct options to easily edit the photo as required. Setting the quality of the photo and setting a grade can be done by the method easily. This allows staying in contact with others better, and not sending too much data or photos revealing too much, limiting quality, resolution, etc. as desired, monitoring and controlling the progress of exchange and A.L. with a plurality of people/recipients.

### Method 21—Compute Fairness in Pictures Exchanges

a. Calculating fairness of pictures exchanges may include a comparison in quantity, quality and access levels between what was sent and what was received.

b. Various approaches may be used for that purpose, such as comparing between the complete photo with best quality exchanged, deciding according to number of pixels describing the face, deciding according to number of photos, deciding according to access level.

c. Various criteria may be defined for what constitutes a fair exchange of photos, including for example: the number of photos transmitted by each party and the quality of each. The system can then monitor the exchange of photos and warn of an “Unfair” or unbalanced exchange.

End of method.

### Method 22—Making Pictures Accessible to Others

a. User prepares pictures, assigns a Grade to each; user assigns an

Access Level to each of other people. The others can get (read, download) pictures whose Grade is lower or equal to their corresponding Access Level. The pictures can be stored in user's PC or in a server on the net, or a mainframe. Above a predefined grade level—personal pictures, not to be sent automatically but only manually.

b. pictures are stored in PC/server/mainframe, which may receive pictures from others.

c. A PC then sends picture automatically or optionally prompts the user for permission in response to a received picture.

It can select a picture with the same grade/quality as that received, under user definitions, for example send PV1 if received a PV with high quality.

d. Keeping track of messages sent/received—what data; to whom (addressee); when; parameters/characteristics.

Transmissions management and MLS.

End of method.

### Method 23—Automatic Gatekeeper

a. An automatic gatekeeper, watchdog, sentinel—protects from inadvertently sending a picture with too good a quality—to protect children playing with a camera from endangering themselves, exposure to perverts or dangers on the net. Preserves privacy, personal security.

b. Supervise/manage in real time the transmission of pictures according to their resolution/quality.

c. Asks “Are you sure” or for password before sending a high quality picture. If not authorized—block transmission or reduce quality before transmit, or

block eyes area (censored picture), etc.

d. It may block certain areas or limit their quality/resolution as defined.

End of method.

### Method 24—Managing Picture Transfers

a. Picture messaging method—prepare pictures versions and store them, to be read/downloaded by others.

b. Some options may be relevant while working in RT.

Some options may be relevant while working with grades.

RT<—>Not RT: may be used with the same program, device or interface but only in a different mode.

c. With Grades <—>Without Grades: These modes can be combined, so that some photos have grades, or that it is possible to send versions instantly under manual control, ignoring their grades (manual override).

For example, sending while in a hurry, sending to someone trustable, or sending from a device not supporting grades, to which some photos where transferred, sending PV for which a grade has not been defined yet.

d. MLS: in all of the options a log may be used, monitoring what was sent to whom and when, with options to:

remind the user—send a version to that person, check other's photos according to access level given to the user, in case he forgot to do so. remind the user—to ask for a version of a photo from that user, in case the other person did not give a satisfying version, as was expected by the user.

e. Warn the user—In case someone insistently, persistently, insidiously only asks for photos for PVs once in a while, without reciprocating. An innocent user may be tricked into unfair, unbalanced exchanges.

It may limit maximum grades, to individuals or to groups, of sendable PVs.

f. Monitor Parts—in case parts where sent out which pertain to a larger complete photo, for example where the pictures are parts of a jigsaw puzzle, then the user can see what did he send, and according to that may decide what to send next. The jigsaw puzzle may pertain to either received or sent pictures, and the present invention may be used in either case, to help decode or encode it, respectively.

g. Access levels granted, Classes and Grades of photos—may be either made visible to the recipient, or not.

End of method.

5. Personal Pictures Messaging System

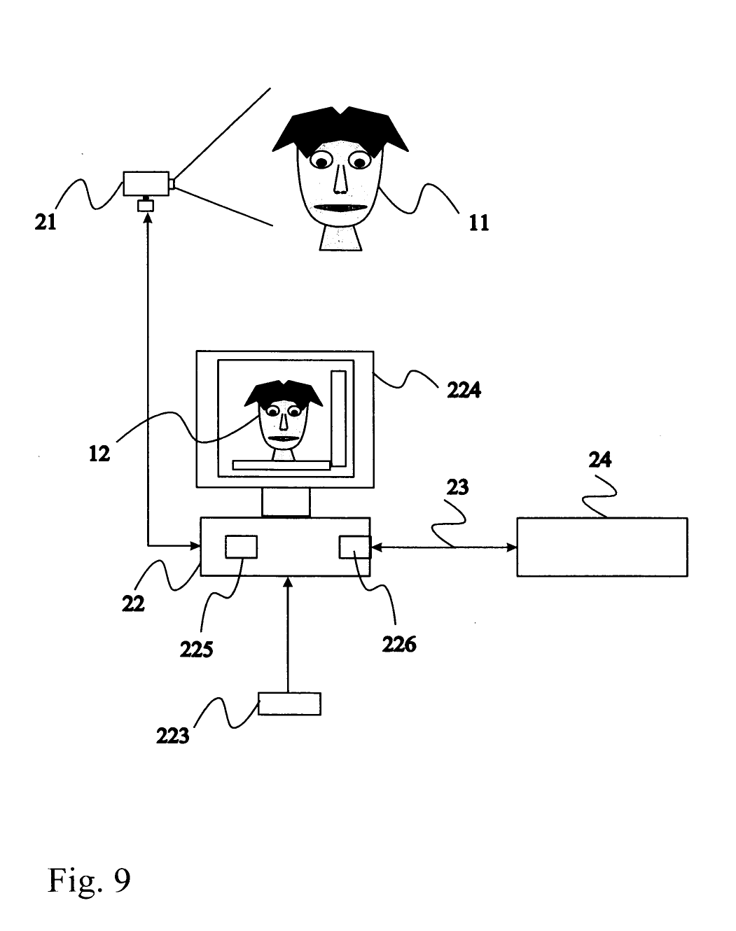

FIG. 9 illustrates a picture messaging system contained in a user's PC.

The system or method according to this invention may be implemented in a Personal Computer PC, another type of computer, Cellular Phone, Palm, Digital Signal Processor, camera or in any other electronic device with display means and input/output means. This will be referred as the PC.

It is possible to use a webcam or its equivalent 21. It is then possible, using a software in a PC 22, to monitor the photo 12 in real time and define limits, for example limiting the quality for certain access levels. Thus, the people who see the photo will not be able to reveal the face or any other areas even if the user approaches or is close to the webcam, or if the resolution of the webcam is increased. This is also a good security measure. The system may use a simple Interface.

In addition, the program may be set up to block one or more areas of the photo, for example the eyes, even if the user is moving, causing the location and/or size of the eyes is changed within the photo—this is done by recognizing the eyes, in this example, by the program and then blocking that area as required before sending the photo, through means 23 to other PCs 24.

The software may run on the user's PC 22, or using other software and/or hardware to implement the method.

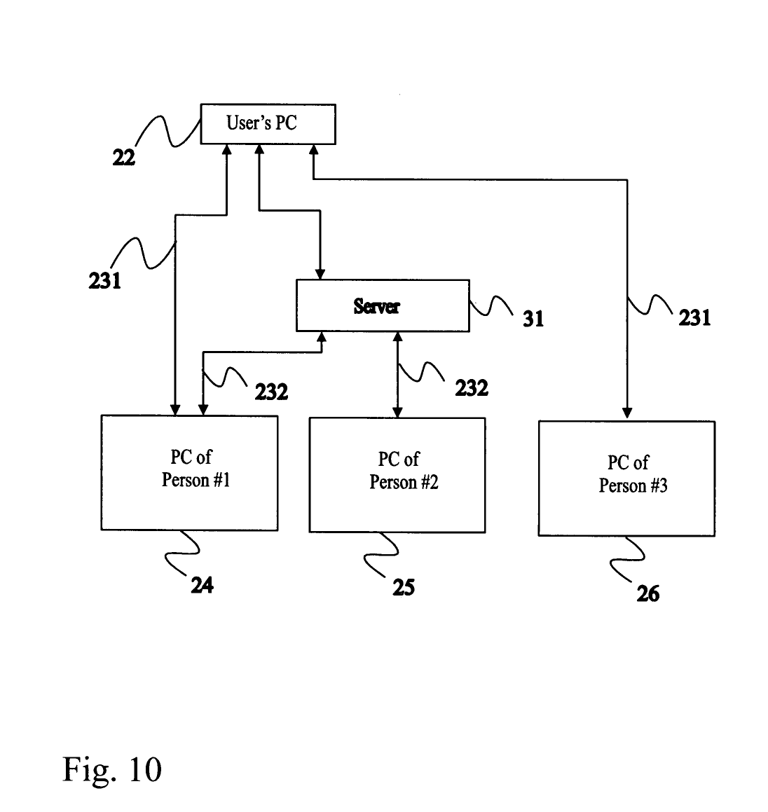

FIG. 10 illustrates a picture messaging system wherein the software and pictures are stored on a server on the net, under control from a user's PC.

The software and/or pictures on server on the net or in a mainframe or central computer, may be controlled from user's PC through Internet. Such control may be implemented using for example: the Hypertext Markup Language (HTML), Extensible Markup Language (XML), Java, applet, script, secure server/client side application, API, DLL, plug-ins, Flash, Active-X, Perl Database Interface (DBI), Common Gateway Interface (CGI), TSR, WAP, SMS, MMS (multimedia messages).

A first user's PC 22 (the description of a user as first, second, etc. is just for the description; actually they all have equal rights to communicate) may communicate directly with a second user's PC 24 through a direct connection 231 between users. Similar direct communications may be established with a third user's PC 25 (these are representative example for the multitude of users on the net) and a fourth user's PC 26.

Another type of communications may use indirect connection 232 between users, through a server 31 on the net. Server 31 may be one of a multitude of servers there. Such indirect connections may be implemented with Internet links 52—various types, wired or wireless.

### Method 25—Using the Messaging System

a. Chat using a server through channel 232, such as a server with chat rooms, a server for dating, or sometimes a chat using a messenger in which the connection is through a server.

b. In this case, the user can give other people details

regarding how to contact him, such as accessing his username through a server, through a web site, or by a direct connection such as with IP address, phone number, etc.

c. Other people can access the photos of the user either directly or indirectly, according to implementation and to what was defined by the user.

d. The communication with person #1 PC 24 is done both directly and indirectly, such as meeting in a chat room and then chatting through a messenger software or directly between IP addresses, etc.

Maybe person #1 PC 24, chatted directly with the user using a cellular phone, and then the user gave that person the details for indirect access through a web site and to some photos there.

e. The communication with person #2 PC 25 is done completely indirectly, such as meeting in a chat room which uses a server, or at a dating web site, then the user gave access to that person to photos at his site, or at any server.

This access can be given using a software on the server which manages the photos and allows all described operations, thus the user can grant access to a PV, reveal details within a PV, or ask for PVs in return such as using mutual mode while the whole operation is done through a server with no direct connection between the user and the other person.

The account of the user in the server is controlled by the user, allowing him to grant access, define photos, and set access level to other people. It can be controlled in real time while chatting with other people, or offline, allowing people with access to connect the account of the user in the server at their free time.

The communication with person #3 PC 26 is done completely directly, such as chatting through a messenger program, or sending photos between cellular phones. In these cases the communication would usually be in real time, when the user and the person are on-line, allowing to easily sending and receiving photos, taking photos and controlling their quality and editing them without requiring much hardware or consuming long time, allowing relatively instant and spontaneous photos exchanging.

f. source, type of pictures:

webcam, digital camera, cellular phone, file/storage device, scanner, USB, Graphics card, Infrared connection, Bluetooth connection, etc.

g. gatekeeper, protects in real time from unauthorized/illegal pictures (MLS) sending. Monitor and block wireless transmissions.

Supervise access levels. Block high grade/quality pictures from being accidentally sent.

h. pictures protection—secure sending, encryption, password.

These options may be required or defined by the user. Existing or downloadable encryption tools/software within the PC may be used as well.

End of method.

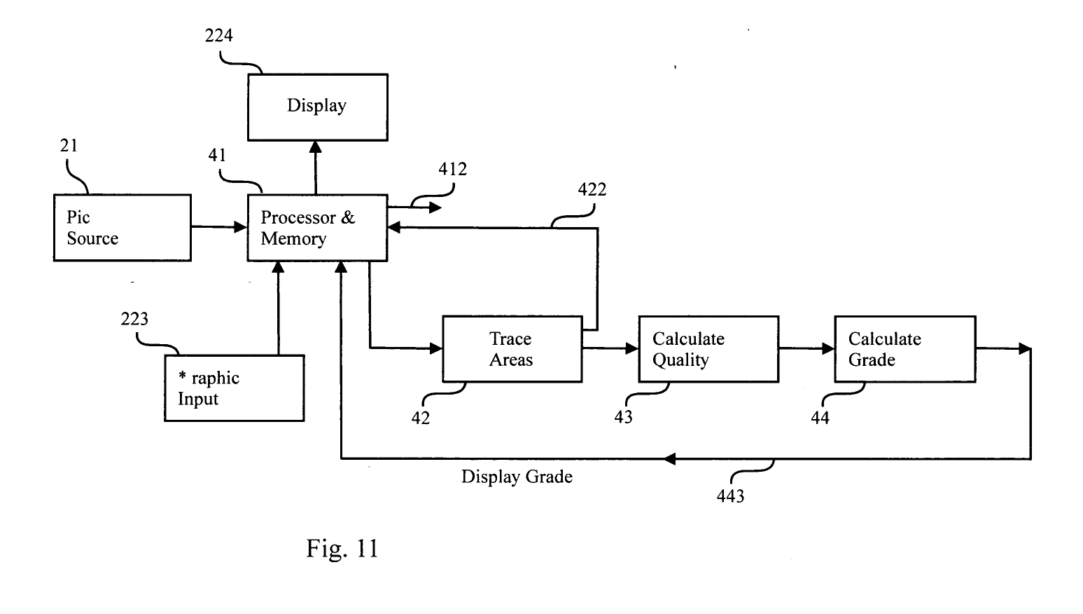

FIG. 11 details a system supporting smart pictures edit and grade setting

Applications: to edit/censor pictures.

Mode of operation: manual—edit picture, see grade, continue edit until satisfactory.

Area selection—manually, or by entering or selecting with tool/mouse a desired area such as “eyes”, “mouth”, “nose”, whereupon the system will search for, locate and select the required area to be edited.

It may be also implemented in the shape of a device to work in RT.

A picture input means 21 (picture acquisition) such as a camera, cellular phone with camera, webcam or its equivalent, is connected to a processor/controller with memory 41. Display means 224 may be used to display a picture and additional info.

User interface input means 223 such as a keyboard, mouse, pen-shaped input means, graphic tablet, light pen, ultrasonic input means (2D or 3D) may be used to input a user's commands. An out channel 412 may be used to transmit PVs, usually processed versions.

An areas contour detection, recognition/identification/selection means 42 may preferably use automatic ID to trace an area of interest. This allows an easy to select and edit system, to create an edited or censored version of a picture.

A define/display selected area channel 422 is used to display the selected area, for the user to check it.

A compute quality means 43 with a compute grade means 44—as compound (such as weighted quality) are used to compute the grade of the picture, which is transferred through a display grade channel 443 to the processor 41 for display along with the picture itself.

As the user edits the picture, the updated grade is computed and displayed, to allow the user to edit the picture and create PVs until the desired grade is achieved. The picture version can then be sent out or transmitted or saved in memory through channel 412.

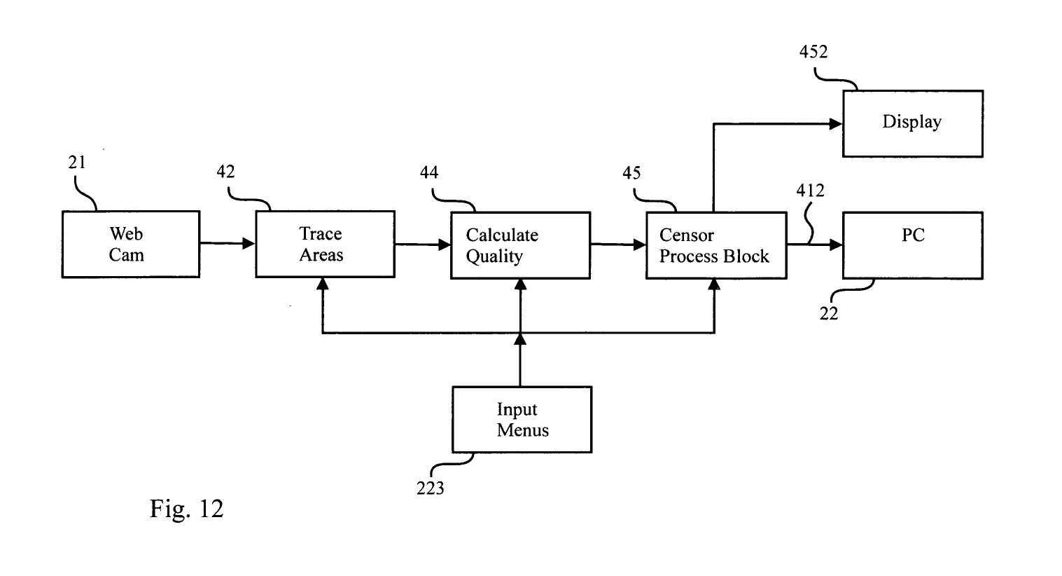

FIG. 12 details a pictures processing interface system for a webcam

1. block between webcam—PC

2. compute grade, display it. select area, display for smart edit

It functions as interface between camera and output, to limit the grade of pictures sent/output from the webcam, or the camera.

Operation: automatic—select required grade, then does iterations of reducing picture quality or re-editing PV and measuring grade until within spec., then sends it through channel 412.

The system includes picture input means 21 (picture acquisition)—camera, cellular phone with camera, digital camera, webcam or its equivalent, whose output is to be connected to a user's PC 22.

The protection system includes areas contour detection, recognition/identification/selection means 42 preferably automatic ID, allowing easy select and edit pictures, to create a censored version, or new PVs.

A compute grade means 44 is connected to censoring/grade limiting means 45 to limit the grade of pictures output, means 45 may implement MLS functions as well.

The system may include display censored/grade limited picture means 452 to display the processed picture version.

User interface input means 223, such as a keyboard, mouse, pen-shaped ultrasonic input may be used to control the system and its operation and parameters.

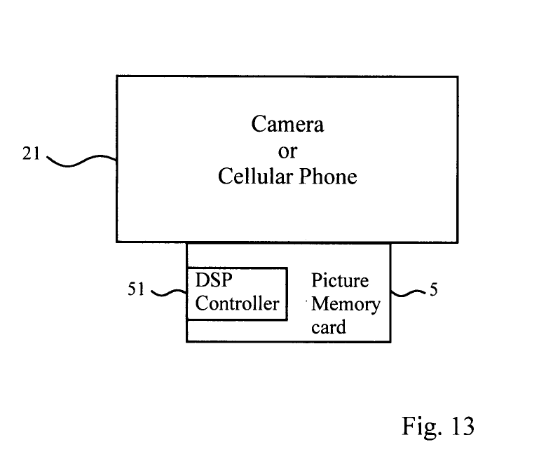

FIG. 13 details an add-on system for smart picture processing. It may be implemented as an add-on to a camera or cellular phone—SIMM, card, etc.

The system includes a picture input means 21 (picture acquisition) such as a standard digital camera with an add-on memory card (or other means). In the new system, the add-on means is replaced with a new add-on memory/editing means 5 (card, module, SIMM, IC, etc.). The new means 5 includes a memory for pictures, and also a digital signal processor DSP means 51.

A memory card/chip/module/SIMM in camera, phone—is replaced with new device having the same shape, but also including processor—to compute grade, block/censor pic areas or all:
webcam or RT input means
computer with means for editing, viewing, monitoring, controlling picture
means for sending the resulting picture in RT to others.

compute grade stages:
identify parts of body or face
compute quality in each
compute grade=sum of (quality each part)*weight

or:
input, open, receive picture
review+analyze
change resolution automatically
recognize areas=> edit
calculate quality

Add-on to camera—replaces memory card/chip. Adds control/signal processing hardware and/or software. Then pics written to memory will also be processed per received instructions to edit, enhance, limit grade, etc. Benefit: upgrade to existing cameras, to achieve the benefits of the present invention therein.

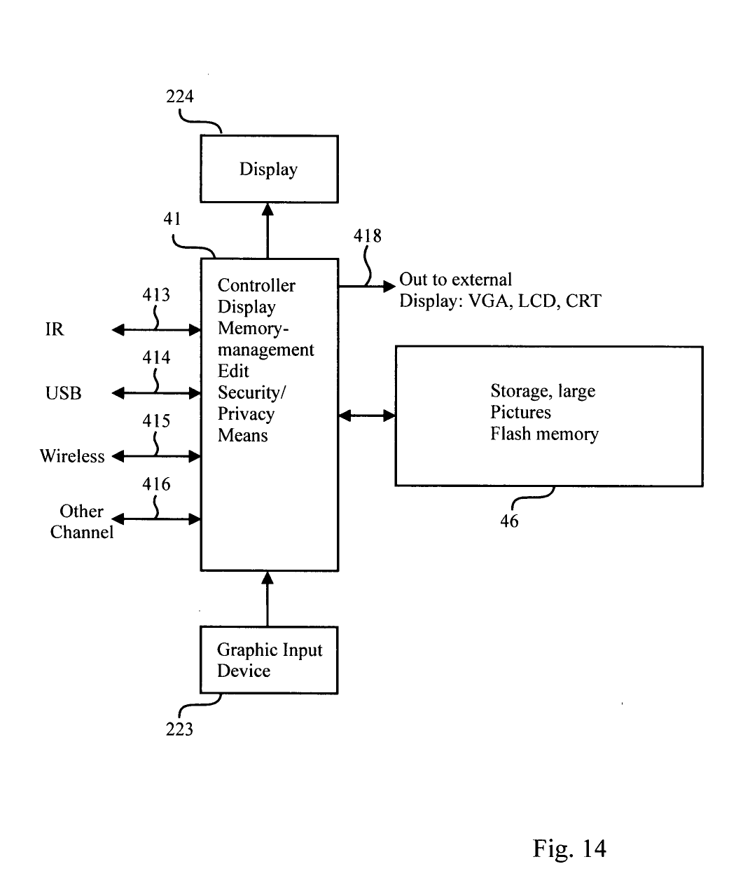

FIG. 14 details a portable pictures storage/display/transfer system for immediate, easy display to user in a low cost, portable device.

There may be problems with viewing digital pictures: With the proliferation of digital cameras, people can take plenty of pictures with ease, and they do. However, there is the problem of viewing the pictures, and without the expensive camera. People give photos to others who may not own a camera. Hard copies may be expensive to make and bulky to store and view. The quality of hard copies will degrade with time. A digital picture is forever.

Digital pictures cannot be arranged in a nice album which is always ready at hand for viewing. Rather, digital pictures are invisible as such. How then can the user show her digital pictures to friends?

The present invention facilitates viewing of digital pictures, in a simple, easy to use, low cost device, as detailed in FIG. 14. The system may store pictures, manage pictures transfer to/from the device, implement a smart picture edit method and display the pictures.

The system includes a processor/controller with memory 41 with large pictures memory storage means 46 (i.e. flash memory) and display means 224.

It further includes user interface input means 223—keyboard, mouse, pen-shaped input means, graphic tablet, light pen, ultrasonic input means (2D or 3D).

Pictures may be transferred to/from the device using various channels, such as an infrared (IR) input/output I/O channel 413, a universal standard bus (USB) I/O channel 414, a wireless, such as a Bluetooth or cellular, I/O channel 415 or other I/O channel 416.

The device may also include a picture out channel 418 to a large display.

The above device may be advantageously used as a pictures album for digital pictures. It is low cost, does not take much space and is easy to use, and allows easy editing and secures PVs. It is also possible to use MLS.

Another possible problem in prior art is that a user may rather not show some of his/her pictures to another person.

The present invention solves this problem as well: a different version of the pictures may be presented to each of one's friends: a different subset (class) of the pictures stored, with a different censoring applied thereto.

Implementation: using the new method of assigning a class and grade to each picture and to each of one's friends, as detailed in the present disclosure.

Source: digital cameras now widely used, but expensive . . . this viewer is low cost. no need for hard copy or PC . . . .

Can show different grade/class to each friend.

The system can be used to easily edit pics to create different PVs either manually or automatically. It can be used with graphic input device, such as a computer mouse. preferably use a pen-shaped pointing device, such as one using ultrasonic sensors.

Ultrasonic sensors in the air can measure a user's fingers movements in two or three dimensions at high resolution and fast response, thus are particularly useful in a human-machine interface for a pictures handling system.

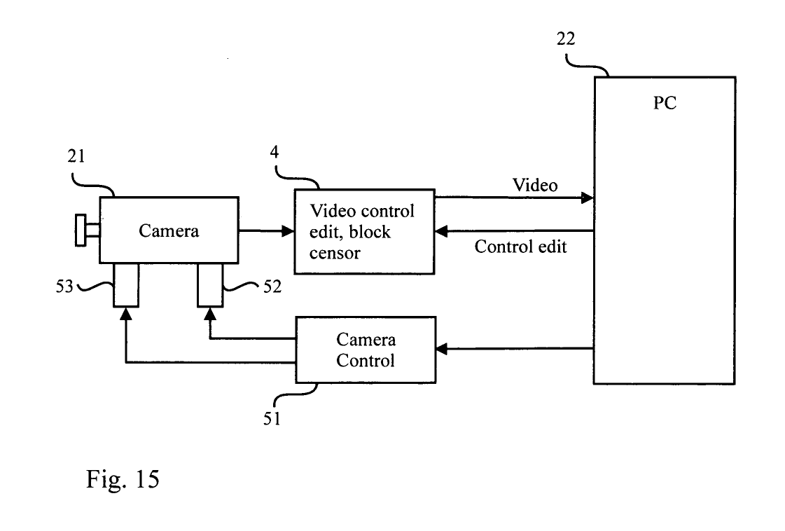

FIG. 15 details a webcam enhanced with user protection means and remote control means. It may be desirable to control the orientation of the webcam from the PC (its azimuth and elevation angles) as well as its zoom.

Further camera controls may include picture rate (frame out rate) and the exposure time.

The system may include a picture input means 21 (picture acquisition) connected to a user's PC 22, further including user interface input means 223—keyboard, mouse, pen-shaped input means, graphic tablet, light pen, ultrasonic input means (2D or 3D).

The system also includes picture privacy protection means 4 to limit grade, etc. A camera control unit 51 receives relevant commands from the PC and controls the camera, for example by applying electrical signals to zoom motor means 52 and azimuth/elevation motor means 53.

Remote control—zoom, orientation control (1 or 2 axes: az, elev) from PC.

A possible problem—privacy, can get out of control. The camera will act not as user intended it to.

Thus, until now not practical—it could get out of control, send pictures the user did not plan/intend to be made public.

But—with our privacy protection means, it can be permitted, since the webcam is enhanced with user protection means and remote control means.

Unit 4 can be integrated within a webcam, such as within webcam chips or hardware.

A software may be included to control preferences, for example to limit quality of face and private areas, limit the number of pixels describing face, etc.

Unit 4 can be password protected in hardware to allow parents, for example, to monitor children while at work, but at the same time the resolution is limited.

6. Menus to User

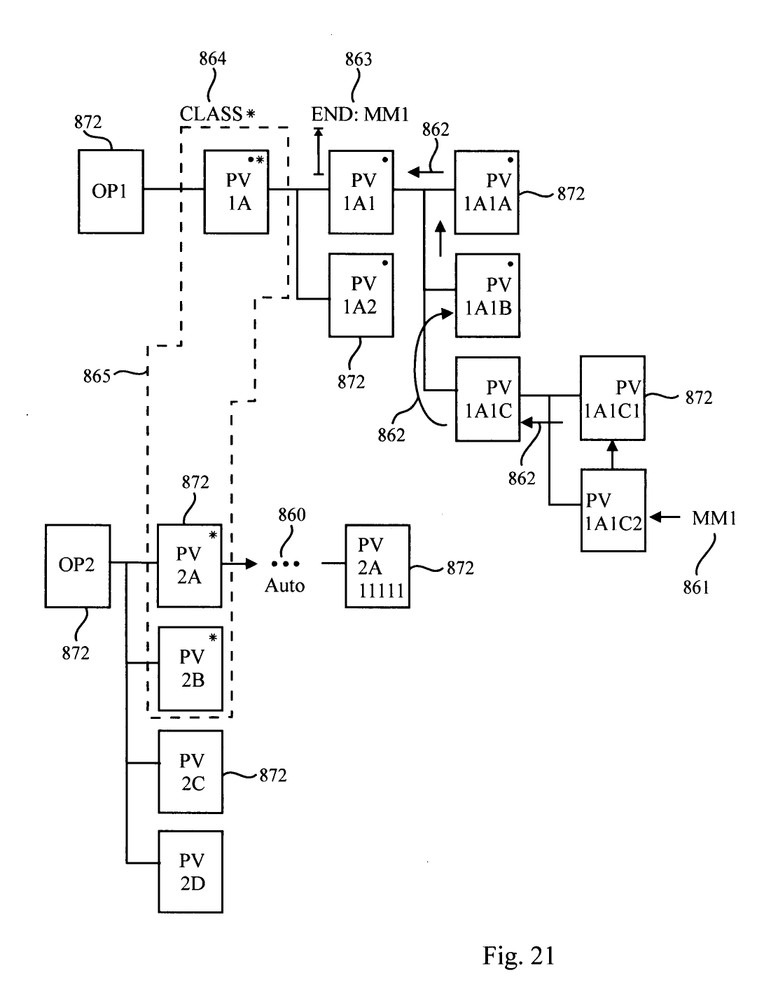

FIG. 21 illustrates one embodiment of presenting onscreen the various picture originals and picture versions, for management purposes.

The pictures may be displayed within small rectangles, in order to present several pictures on screen.

In this figure, each rectangle 872 represents a picture (original: OP or version PV), minimized or sampled.

Within each rectangle 872, there may be only text, however instead of a picture and only when clicking on that picture (or moving mouse above it, for example) the picture would be displayed, within the rectangle or in a different place, but the whole screen would remain and will regain its original appearance as the mouse moves out of that picture/rectangle.

In addition, it is possible that important data would be displayed in each rectangle 872, while the picture is in the background of the text in the rectangle.

Text and data can be displayed below the picture as well, within or outside of the rectangle.

The data can include whatever the user wishes to be displayed, preferably the data will include picture's grade, class and name.

Picture's grade and class may be described visually as well, or instead of in text. For example class may be displayed using a special mark within or near its rectangle, such as an asterisk (*), a circle (o), etc.

A picture may belong to more than one class.

A group of pictures belonging to a class may be also displayed by a dash line, by a special color, by different background color around each picture which belongs to this class, etc.

The grade can be displayed graphically, such as using a brighter border color for a higher grade picture, a graph with one or more bars for each picture, representing the grade, etc.

From each original picture OP can be created PVs by editing and/or by defining automatic operation, such as in the six PVs (2A, 2A1, 2A11 . . . 2A11111).

Some of the PVs can be displayed such as first and last of the automatic PVs.

Automatic definition may include lowering quality automatically, for example lowering quality in 20 dpi for each new PV, or enlarging a blocked/edited area in 5%, etc. units can be absolute, relative or by default, such as “slightly lower resolution”.

From each PV, can be created any number of new PVs, such as 1A1 and 1A2, from 1A.

In addition, each PV may be defined as an OP, so that it can be the initial picture (left most).

The user can easily access and change parameters of each PV, edit it or create a new PV, this can be implemented for example by double clicking with the mouse on that picture.

Mutual Mode 861 can be defined and shown, such as MM1 in this fig. there may be more than one mutual modes, such as MM2, MM3 and so on. Each mutual mode can be shown by arrows 862, indicating the initial PV, such as PV 1A1C2, for MM1, and then the next PVs that will be shown, according to the preferences of the mutual mode, as required. MM1 is ended at PV 1A1 and it can be also designated by text such as: “END:MM1” 863.

However general possible progress in exposing PVs can be easily maintained and edited through this screen.

Each picture can be edited, deleted and its definitions can be changed.

It is possible to move the PVs in the chart, to insert new ones between existing PVs, etc.

It is also possible to use drag and drop in order to easily move PVs.

It can be possible to mark several PVs and then change their definitions at the same time, for example changing their security definitions.

A security icon can be displayed according to security level on each picture.

It can be possible to change size of appearance of PVs on the screen, e.g. to change the size of one or more rectangles, such as by selecting them and then choosing an option for changing their size.

It is possible to see a list and sort PVs and OPs according to time of creation, time of last editing, grade, people to which they were given, rate of success (a PV which resulted in receiving a high quality PV from the other person), classes, name, serial number (to allow similar PVs which created from the same OP together).

It is possible to present or mark 865 only some of PVs, by any one or more parameters, for example display only pictures with grade lower than 80, or display PVs which were created from OP1 and belong to class 864.

The Menus to user may include:
a. Load/save image, set grade, compute quality, edit picture, set grade for each picture version, send to other programs or to communications, assign Access Level to each other person.
b. Interface to user—select pictures, review, edit, read/save,
transmit, set grades/access level
c. A.L.s, Grades and PVs—may be displayed, in case they are used.

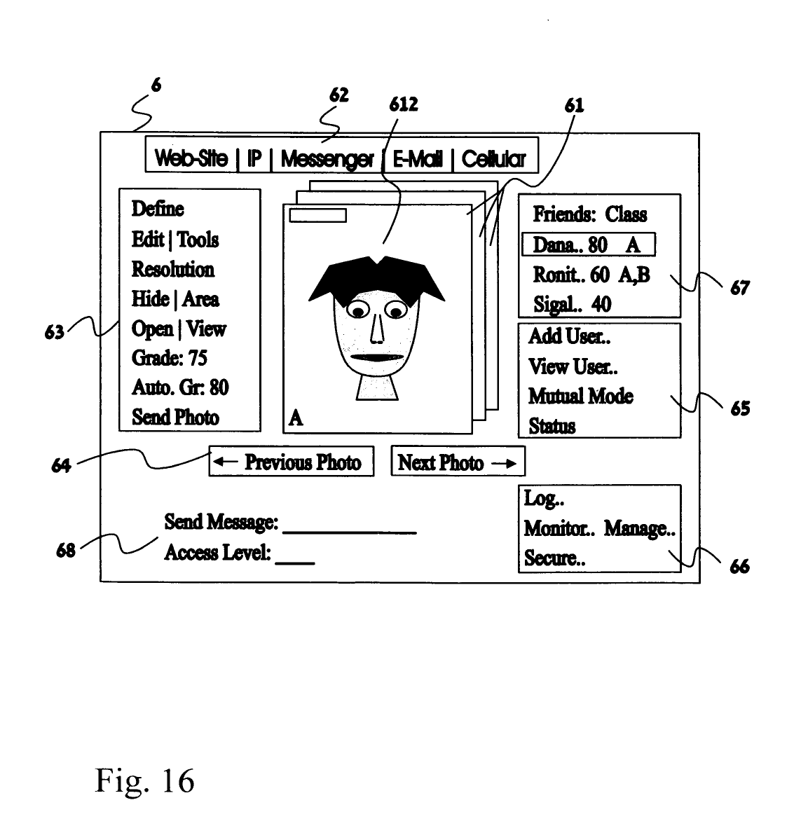

FIG. 16 details one embodiment of a menu to user.

Using a menu/interface 6, it is possible to easily manage photos, send and receive and define access levels and grades to other people. It is possible to open several windows 61, while in each there are one or more different photos or PVs, or with different editing parameters/operators.

In each photo, relevant details may appear such as its quality calculated by the interface, and as was defined or calculated by the user, thus there may be several grades for the photo, and the user can control the mode of operation eventually.

A menu/interface 6 may include a window 61 or several such windows, and a picture editing work area 612. The menu may also include a communications parameters area 62 for managing communications with others, such as easily defining IP or finding user's IP. Picture editing tools area 63 may be used for editing a selected photo.

A pictures selection and management area 64 is used to preview the desired picture, PVs or stream of pictures.

MLS menu 66 allows managing or displaying relevant info.

A chat control and selection area 65 may be used during chat with others, to manage other's A.L., mutual mode and seeing them or what is received from other people.

A picture security/grade control area 66 supports the security features of the invention.

It is possible that the grade given by the interface, referred to as automatic grade, or Auto. Gr. as shown in FIG. 16, will be shown at the side 67 or other place according to the photo selected. Grade values as defined by the user may be shown similarly.

It is possible to use tools, including graphic tools, to edit the photo, or tools to hide details, improve the appearance and remove unwanted details. It is possible to define various areas, and how each area will be treated. It is possible to make several definitions, for different access levels on the same photo.

Thus, the same photo will appear different to different people, according to their access level. For example, a person with access level 48 would see the photo with a resolution of 50 dpi, while a person with access level 71 will see the same photo with a resolution of 75 dpi.

It can be possible to send messages 68, update A.L. easily, according to the PVs which were received from that person.

It is possible to hide or change the illumination for a specific area, Open new photos or manage existing ones.

The interface may be implemented as a plug-in of a messenger or any other communication software or hardware mean. In case it is implemented as a plug-in of a messenger software and/or in case the interface is an independent messenger software and/or in case the interface has messaging capabilities, then a list of friends 67 can be displayed, with their access levels. It is possible to change the access level of each person or friend by the user. It is possible to define classes and grant limited access for each specific class to different friends/acquaintances.

It is possible that photos which belong to a certain class will have a sign, such as “A” telling that only people with access to that class can see that photo.

It may be possible to send messages to each friend and to grant access in real time 68, for example show photo from a webcam to a person and give instant access for that moment only.

It is possible to use a mutual mode, in which photos will be exchanged in a fair manner, for example exchanging a similar number of analogous PVs; exchanging PVs with similar exposure of body/face, exchanging photos with similar quality, resolution or size, etc.

Using this mode, it is possible to automatically block transmissions to some people, until they send photos with quality or size or resolution or other parameters as required.

The interface may support different communication means 62 easily, or work independently, as defined by the user and according to the implementation.

Any data may be presented on the PV, and can be stored on a Log file or as a graphical part of the PV's file, or as data in PV's file.

It is possible to automatically remove this data just before sending PV's file.

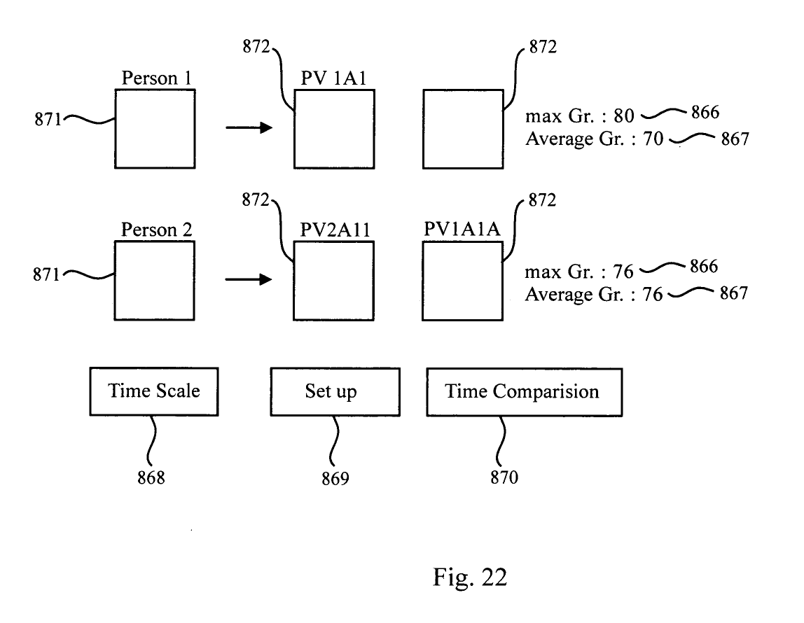

FIG. 22 describes a screen or menu, which enables viewing each person's details together with the pictures and PVs which have been sent to that person.

The messaging-related data which has been logged in the system can be viewed by the user from various points of view, for various purposes.

It is possible to see any relevant details, especially:

Max.Gr 866 the highest grade from the PVs which were sent to the person.

Average Gr. 867 the average grade of the PVs which were sent to the person.

Current A.L. of that person, etc.

Dates: It is possible to see relevant dates at which PVs were sent/accepted, it is possible to compare ratio of sent/received against time, for example how many PVs were sent/received to/from that person in last month, this can be implemented by pressing “time scale” or equivalent button 868.

Time Comparison 870 comparison in time may be used for example with this menu.

Setup 869 it is possible to edit definitions or demands for that person, etc.

In each rectangle, there may appear a PV or OP similarly to what was described.

In person's rectangle 871 there may appear received PVs from that person with their highest grade, most recently received PV, etc. It is possible that more than one PV or rectangle of that person would appear.

Relevant text describing the rectangle and its contents can appear near and/or within each rectangle.

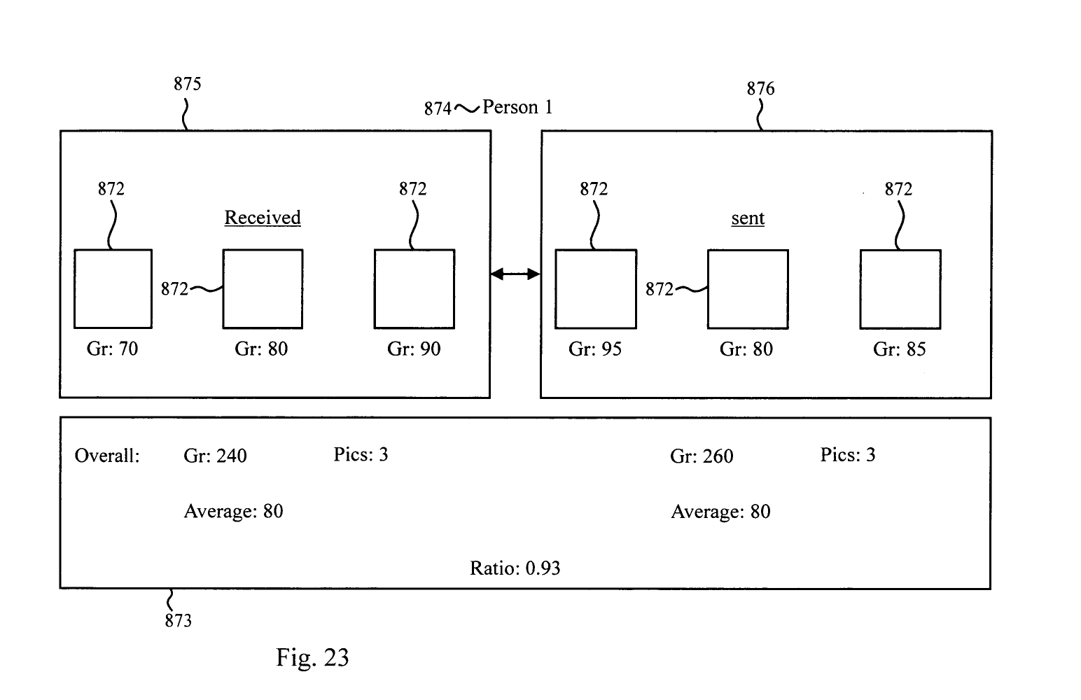

FIG. 23 describes a screen or menu which allows to see the PVs that were received versus the PVs which were sent.

It is possible to see details of pictures received 875 versus pictures was sent 876 for each person, while also displaying person's name and relevant data 874, in order to easily compare fairness.

Additional data may be displayed, for each rectangle/PV 872, in addition general information 873 can be presented, such as:

Overall:

Gr.: the sum of all Grades Gr. for that person, separated for what was sent and what was received.

Pics.: The number of PVs or pictures.

Average: The average Gr. of all grades received, and sent separately.

Ratio: a number representing fairness between what was received divided to what was sent, thus roughly if ratio>1 then more was received than sent (or with better quality, etc.).

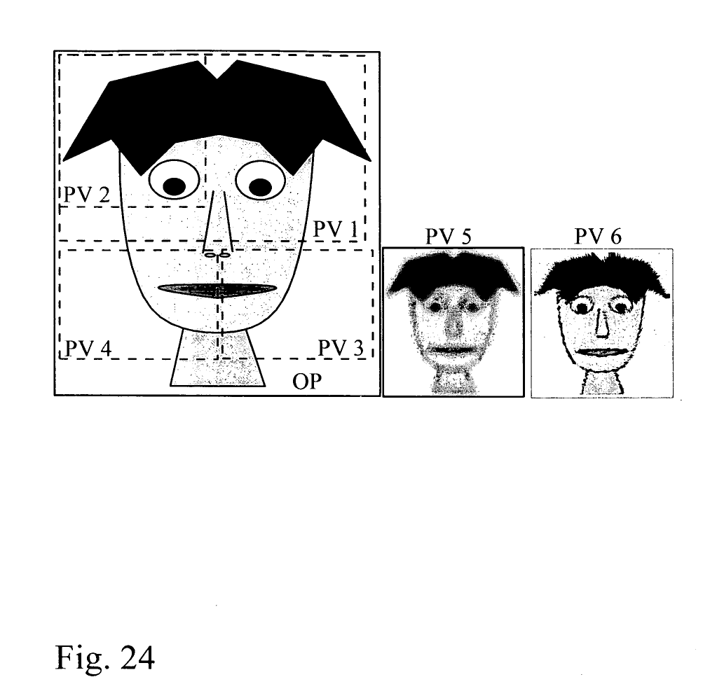

FIG. 24 describes a screen or menu which allows defining steps and managing the revealing of one or more PVs to others.

It is possible to see the original picture OP along with picture versions PV, on the same screen.

This can be useful in order to manage PVs, send them, set their grades, etc. The areas in which each PV has an influence can be designated on the screen as well, or can be shown near the OP such as PV5 and PV6 which show the whole OP along with the modifications.

It is possible to expose each time part of an OP or a PV, for a specific person, and progress as desired, or advance according to a systematic approach, for example by dividing the OP to parts, and defining a PV for each part, such as PV1 to PV4, it is then easier for the user to send each time the next part as desired, or monitor easily what was send—it can be shown on the screen which PVs where sent by marking them graphically for example.

It is possible to supply the user with tools to easily divide the PV or OP into parts and different PVs either automatically or manually, such as by drawing lines where each line makes a division and creates new PVs from both of its sides.

7. Interface with Other Programs in PC

This aspect of the invention refers to the Interface/interaction with other programs/applications in a PC/computer/server/other equipment.

Possible embodiments of the interface with other programs may include:
a. Independent application, includes all modules/functions for pictures messaging.
b. Plug-in for other program, embedded application, subroutine under another application, such as ICQ, Internet chat.

The other application manages addresses and communications, etc.
DLL, in toolbar, active-x, module
c. Independent program, limited to pictures input, processing, storage.
   Another program may use these processed pictures in communications
d. A combination of MLS:
   1) Monitor—mutual mode, demands, quality/grade/resolution calculations.
   2) Log—what was sent, received, ratios, definitions, remarks.
   3) Secure—Block, limit/edit, encrypt, warn.
   4) Manage—easy preview and access, manage PVs.

It will be recognized that the foregoing is but one example of an apparatus and method within the scope of the present invention, and that various modifications will occur to persons skilled in the art upon reading the disclosure set forth hereinbefore.

1. A method for messaging digital pictures with others by sending a user's pictures to a plurality of recipients, wherein the pictures include a user's face and/or body and/or parts thereof,
characterised in that, prior to sending the pictures, further steps are performed for achieving a controlled level of a user's personal exposure with each recipient, comprising:
a. evaluating a personal exposure in the picture by computing an amount of personal data revealed in the user's face and/or body and/or parts thereof;
b. comparing the personal exposure in the picture with an amount of exposure allowed with an intended recipient;
c. if the amount of personal exposure revealed in the picture is greater than the allowed level of personal exposure with the intended recipient, then editing the picture to reduce the level of the user's personal exposure;
and wherein the pictures include one or more of the following: a photo, photograph, image, pic, file, stream of images, digital photo, stream from webcam, an original picture (OP), a picture version (PV), one picture or a stream of pictures or frames.

2. The messaging method according to claim 1, wherein the personal exposure is computed either:
a. as an Exposure, wherein the Exposure comprises a value indicating the measure of intimacy revealed in the picture, taking into account specific private areas present in the personal picture and the resolution/quality in each area; or
b. as a function of Resolution values, wherein the Resolution comprises a value indicating a pictorial/visual information contained in an area of a person's body and/or face; or
c. as a Quality, wherein the Quality comprises a value indicating the interest in the picture, derived from the resolution values and their relative importance to the user; or
d. as a Grade of Picture, wherein the Grade of Picture comprises a number assigned to a picture, indicating the degree of its privacy to owner or a sensitivity to its disclosure.

3. The method for messaging pictures according to claim 1, characterised in that the evaluation of the amount of revealed personal data includes the steps of:
a1. recognition of selected areas of a person's face and/or a person's body in a picture;
a2. measuring the amount of information contained in each part thus selected.

4. The method for messaging pictures according to claim 3, characterised in that the recognition of the selected areas of a person's face and/or a person's body is either:
a. automatic; or
b. manual, wherein the sender assists and guides the automatic recognition process, thereby facilitating it.

5. The method for messaging pictures according to claim 3, characterised in that the measurement of the amount of information in each part comprises counting the number of pixels in that part.

6. The method for messaging pictures according to claims 1, wherein the characteristics measured are saved in a table including the amount of information in each part of the face and/or body.

7. The method for messaging pictures according to claim 1, characterised in that the evaluation of the amount of revealed personal data comprises:
a1. defining a user's criteria for Quality in a personal picture, indicating the importance of each face and/or body part as indicative of the level of interest in the picture, expressed as a set of weights to be assigned to each part of face or body;
a2. computing Resolution in the picture, including an automatic recognition of each part of a person's face and/or body and the information in each part;
a3. computing the quality of a picture, QualityA, using the equation:
QualityA=ΣR(n)*W(n)
wherein
Σ represents summing of terms over n
R(n)—resolution of area i of body or face
W(n)—weight assigned to area i, according to the measure of interest attached to that body area.

8. The method for messaging pictures according to claim 1, characterised in that the evaluation of the amount of revealed personal data comprises:
a1. defining a user's criteria for an Exposure in a personal picture, indicating the importance of each face and/or body selected areas as indicative of the level of personal exposure in the picture, expressed as a set of weights to be assigned to each area within face or body, and wherein the importance of naked skin in each part is optionally defined.

9. The method for messaging pictures according to claim 8, wherein determining whether each area is covered or naked skin using either:
a. an automatic algorithm using color, texture, other characteristics or a combination thereof; or
b. a manual input from the user to indicate whether each area is covered or naked.

10. The method for messaging pictures according to claim 1, characterised in that the evaluation of the amount of revealed personal data comprises computing an Exposure as a weighted sum of resolution values for specific private areas.

11. The messaging method according to claim 1, further including the step of performing Manage, Log and Secure (MLS) for personal communications by keeping track of pictures and their characteristics, properties assigned to a plurality of possible recipients of pictures and communication activities performed with others.

12. The messaging method according to claim 1, further including the step of monitoring an exchange of pictures with each of a plurality of other persons, to evaluate the fairness of the exchange and to display any imbalance in the exchange.

13. A system for messaging digital pictures with others, comprising picture input means connected to processor/controller means with memory means, and an output channel for sending the pictures, characterised in further including means for achieving a controlled level of a user's personal exposure prior to sending the pictures, comprising:
a. means for evaluating a personal exposure in the picture by computing an amount of personal data revealed in the user's face and/or body and/or selected areas thereof;
b. means for comparing the personal exposure in the picture with an amount of exposure allowed with an intended recipient;
c. means for deciding whether the amount of personal exposure revealed in the picture is greater than the allowed level of personal exposure; and
d. means for editing the picture to reduce the level of the user's personal exposure, if the amount of personal exposure revealed in the picture is greater than the allowed level of personal exposure;
and wherein the pictures include one or more of the following: a photo, photograph, image, pic, file, stream of images, digital photo, stream from webcam, an original picture (OP), a picture version (PV), one picture or a stream of pictures or frames.

14. The messaging system according to claim 13, further including means for computing the personal exposure as either:
a. an Exposure, wherein the Exposure comprises a value indicating the measure of intimacy revealed in the picture, taking into account specific private areas present in the personal picture and resolution/quality in each area; or
b. a function of Resolution values, wherein the Resolution comprises a value indicating a pictorial/visual information contained in an area of a person's body and/or face; or
c. a Quality, wherein the Quality comprises a value indicating the interest in the picture, derived from the resolution values and their relative importance to the user; or
d. a Grade of Picture, wherein the Grade of Picture comprises a number assigned to a picture, indicating the degree of its privacy to owner or a sensitivity to its disclosure.

15. The system for messaging pictures according to claim 13, characterised in that the means for evaluating the amount of revealed personal data include:
a1. means for recognizing selected areas of a person's face and/or a person's body in a picture;
a2. means for measuring the amount of information contained in each part thus selected.

16. The system for messaging pictures according to claim 15, characterised in that the means for recognizing selected areas of a person's face and/or a person's body are either:
a. automatic; or
b. manual, wherein the sender assists and guides the automatic recognition process, thereby facilitating it.

17. The system for messaging pictures according to claim 15, characterised in that the means for measuring the amount of information in each part comprises means for counting the number of pixels in that part.

18. The system for messaging pictures according to claim 13, wherein the charactertics measured are stored in the memory means in a table, wherein the table includes the amount of information in each part of the face and/or body.

19. The system for messaging pictures according to claim 13, characterised in that the means for evaluating of the amount of revealed personal data comprise:
a1. means for defining a user's criteria for Quality in a personal picture, indicating the importance of each face and/or body selected areas as indicative of the level of interest in the picture, expressed as a set of weights to be assigned to each area within face or body;
a2. means for computing Resolution in the picture, including an automatic recognition of each part of a person's face and/or body and the information in each part;
a3. means for computing the quality of a picture, QualityA, using the equation:
QualityA=ΣR(n)*W(n)
wherein
Σ represents summing of terms over n
R(n)—resolution of area i of body or face
W(n)—weight assigned to area i, according to the measure of interest attached to that body area.

20. The system for messaging pictures according to claim 13, characterised in that the means for evaluating the amount of revealed personal data comprises:
a1. means for defining a user's criteria for an Exposure in a personal picture, indicating the importance of each face and/or body selected areas as indicative of the level of personal exposure in the picture, expressed as a set of weights to be assigned to each area within face or body, and wherein the importance of naked skin in each part is optionally defined.
